(19) United States
(12) Patent Application Publication
(10) Pub. No.: US 2023/0108372 A1
(43) Pub. Date: Apr. 6, 2023

(54) TECHNIQUES FOR BACKWARDS-COMPATIBLE SIDELINK COMMUNICATIONS

(71) Applicant: QUALCOMM Incorporated, San Diego, CA (US)

(72) Inventors: Tien Viet Nguyen, Bridgewater, NJ (US); Sourjya Dutta, San Diego, CA (US); Gabi Sarkis, San Diego, CA (US); Shuanshuan Wu, San Diego, CA (US); Kapil Gulati, Belle Mead, NJ (US); Gene Wesley Marsh, San Diego, CA (US); Shailesh Patil, San Diego, CA (US)

(21) Appl. No.: 17/947,805

(22) Filed: Sep. 19, 2022

Related U.S. Application Data
(60) Provisional application No. 63/246,436, filed on Sep. 21, 2021.

(51) Int. Cl. H04W 72/04; H04W 72/02

(52) U.S. Cl. CPC H04W 72/048; H04W 72/02; H04W 72/0406

(57) ABSTRACT

Methods, systems, and devices for wireless communications are described. A user equipment (UE) may be configured to select, from a resource pool for sidelink communications, a set of resources for one or more sidelink messages to be performed by the UE. The UE may select an additional resource to transmit a resource reservation for an earliest resource of the set of resources, the selection of the additional resource based on a time interval between the additional resource and the earliest resource satisfying a time threshold. The UE may transmit, via the additional resource, An inter-UE (IUE) coordination message including an indication of the earliest resource within a first-stage sidelink control information portion of the IUE coordination message, and may transmit a first sidelink message of the one or more sidelink messages within the earliest resource indicated via the first-stage sidelink control information portion of the IUE coordination message.

### CROSS REFERENCE

The present Application for Patent claims the benefit of U.S. Provisional Pat. Application No. 63/246,436 by NGUYEN et al., entitled “TECHNIQUES FOR BACKWARDS-COMPATIBLE SIDELINK COMMUNICATIONS,” filed Sep. 21, 2021, assigned to the assignee hereof, and expressly incorporated by reference herein.

### FIELD OF TECHNOLOGY

The following relates to wireless communications, including techniques for backwards-compatible sidelink communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications systems may support sidelink communications between UEs. However, in wireless communications systems which include UEs of differing capabilities, such as reduced-capability or Release 16 (Re16) UEs, and non-reduced-capability or Release 17 (Re17) UEs, not all UEs may be capable of receiving and decoding messages which reserve sidelink resources, which may result in increased interference.

### SUMMARY

The described techniques relate to improved methods, systems, devices, and apparatuses that support techniques for backwards-compatible sidelink communications. Generally, the present disclosure supports techniques for scheduling sidelink communications for Release 17 (Re17) UEs which are backwards-compatible (e.g., understood) by reduced-capability UEs, such as Release 16 (Re16)UEs. In particular, techniques described herein enable Re17 UEs to transmit some sidelink scheduling information via sidelink control information (SCI) messages (e.g., SCI-1) so that Re16 UEs are able to receive and recognize reservations of sidelink resources by Re17 UEs. For example, a UE (e.g., Re17 UE) may use a set of resources for transmitting sidelink messages which are to be selected by the UE or another UE. In some cases, the UE may transmit an inter-UE (IUE) coordination message (e.g., IUE coordination message, or IUE message) which reserves the set of resources, where the IUE coordination message may be decoded by Re17 UEs, but not by Re16UEs. Additionally, the UE may select an additional resource for transmitting an SCI-1 message which reserves the first resource (e.g., earliest resource) of the selected set of resources. In particular, the UE may select the additional resource for the SCI-1 to satisfy timing restrictions associated with SCI-1 such that the SCI-1 is transmitted no more than 32 symbols prior to the first selected resource.

A method for wireless communication at a UE is described. The method may include selecting, from a resource pool for sidelink communications, a set of resources for one or more sidelink messages to be performed by the UE, selecting an additional resource to transmit a resource reservation for an earliest resource of the set of resources, the selection of the additional resource based on a time interval between the additional resource and the earliest resource satisfying a time threshold, transmitting, via the additional resource, an IUE coordination message including an indication of the earliest resource within a first-stage SCI portion of the IUE coordination message, and transmitting a first sidelink message of the one or more sidelink messages within the earliest resource indicated via the first-stage SCI portion of the IUE coordination message.

An apparatus for wireless communication at a UE is described. The apparatus may include a processor, memory coupled with the processor, and instructions stored in the memory. The instructions may be executable by the processor to cause the apparatus to select, from a resource pool for sidelink communications, a set of resources for one or more sidelink messages to be performed by the UE, select an additional resource to transmit a resource reservation for an earliest resource of the set of resources, the selection of the additional resource based on a time interval between the additional resource and the earliest resource satisfying a time threshold, transmit, via the additional resource, an IUE coordination message including an indication of the earliest resource within a first-stage SCI portion of the IUE coordination message, and transmit a first sidelink message of the one or more sidelink messages within the earliest resource indicated via the first-stage SCI portion of the IUE coordination message.

Another apparatus for wireless communication at a UE is described. The apparatus may include means for selecting, from a resource pool for sidelink communications, a set of resources for one or more sidelink messages to be performed by the UE, means for selecting an additional resource to transmit a resource reservation for an earliest resource of the set of resources, the selection of the additional resource based on a time interval between the additional resource and the earliest resource satisfying a time threshold, means for transmitting, via the additional resource, an IUE coordination message including an indication of the earliest resource within a first-stage SCI portion of the IUE coordination message, and means for transmitting a first sidelink message of the one or more sidelink messages within the earliest resource indicated via the first-stage SCI portion of the IUE coordination message.

A non-transitory computer-readable medium storing code for wireless communication at a UE is described. The code may include instructions executable by a processor to select, from a resource pool for sidelink communications, a set of resources for one or more sidelink messages to be performed by the UE, select an additional resource to transmit a resource reservation for an earliest resource of the set of resources, the selection of the additional resource based on a time interval between the additional resource and the earliest resource satisfying a time threshold, transmit, via the additional resource, an IUE coordination message including an indication of the earliest resource within a first-stage SCI portion of the IUE coordination message, and transmit a first sidelink message of the one or more sidelink messages within the earliest resource indicated via the first-stage SCI portion of the IUE coordination message.

Some examples of the method, apparatuses, and non-transitory computer-readable medium described herein may further include operations, features, means, or instructions for transmitting, via a second-stage SCI portion of the IUE coordination message, a data portion of the IUE coordination message, or both, IUE coordination information including an indication of the set of resources for the one or more sidelink messages based on selecting the set of resources.

In some examples of the method, apparatuses, and non-transitory computer-readable medium described herein, the second-stage SCI portion, the data portion, or both, may be unable to be decoded by reduced-capability UEs and the indication of the earliest resource within the first-stage SCI portion may be capable of being decoded by reduced-capability UEs.

Some examples of the method, apparatuses, and non-transitory computer-readable medium described herein may further include operations, features, means, or instructions for transmitting a second IUE coordination message including a second indication of the earliest resource in a first-stage SCI portion of the second IUE coordination message, where the second IUE coordination message may be transmitted prior to the IUE coordination message and transmitting the IUE coordination message via the additional resource based on a second time interval between transmission of the second IUE coordination message and the earliest resource of the set of resources failing to satisfy the time threshold.

Some examples of the method, apparatuses, and non-transitory computer-readable medium described herein may further include operations, features, means, or instructions for transmitting, via the first-stage SCI portion of the IUE coordination message, an indication of a set of multiple subchannels of the earliest resource, where a last subchannel of the set of multiple subchannels may be within the resource pool in a frequency domain, where the first sidelink message may be transmitted via the set of multiple subchannels.

Some examples of the method, apparatuses, and non-transitory computer-readable medium described herein may further include operations, features, means, or instructions for transmitting, via the first-stage SCI portion of the IUE coordination message, one or more FDRI field values including an indication of a subchannel of the earliest resource, where the first sidelink message may be transmitted via at least the subchannel.

In some examples of the method, apparatuses, and non-transitory computer-readable medium described herein, the subchannel includes an initial subchannel of the earliest resource.

Some examples of the method, apparatuses, and non-transitory computer-readable medium described herein may further include operations, features, means, or instructions for transmitting, via the first-stage SCI portion of the IUE coordination message, one or more time domain resource indication (TDRI) field values associated with the earliest resource, one or more frequency domain resource indication (FDRI) field values associated with the earliest resource, or both.

Some examples of the method, apparatuses, and non-transitory computer-readable medium described herein may further include operations, features, means, or instructions for transmitting, via the first sidelink message, an indication of a second resource of the set of resources and transmitting a second sidelink message via the second resource based on transmitting the indication of the second resource via the first sidelink message.

In some examples of the method, apparatuses, and non-transitory computer-readable medium described herein, the time interval satisfies the time threshold if the time interval may be less than or equal to the time threshold.

In some examples of the method, apparatuses, and non-transitory computer-readable medium described herein, the time threshold includes thirty-two slots.

Some examples of the method, apparatuses, and non-transitory computer-readable medium described herein may further include operations, features, means, or instructions for receiving a second IUE coordination message including an indication of a second resource for one or more additional sidelink messages to be performed by a second UE and relaying the second IUE coordination message to at least a third UE.

Some examples of the method, apparatuses, and non-transitory computer-readable medium described herein may further include operations, features, means, or instructions for receiving, via the second IUE coordination message, one or more TDRI field values associated with a relative timing of the one or more additional sidelink messages and transmitting, via the relayed second IUE coordination message, one or more additional TDRI field values associated with the relative timing of the one or more additional sidelink messages.

Some examples of the method, apparatuses, and non-transitory computer-readable medium described herein may further include operations, features, means, or instructions for selecting, from the resource pool for sidelink communications, a second set of resources for the one or more sidelink messages to be performed by the UE, where selecting the second set of resources occurs prior to selecting the set of resources and determining that a second additional resource to transmit a resource reservation for an earliest resource of the second set of resources may be unable to be identified, where selecting the set of resources, selecting the additional resource, or both, may be based on determining that a second additional resource to transmit a resource reservation for an earliest resource of the second set of resources may be unable to be identified.

In some examples of the method, apparatuses, and non-transitory computer-readable medium described herein, the first-stage SCI portion of the IUE coordination message includes one or more bit field values which indicate that the first-stage SCI portion may be associated with the IUE coordination message.

A method for wireless communication at a first UE is described. The method may include selecting, from a resource pool for sidelink communications, a set of resources for one or more sidelink messages from a second UE to the first UE, selecting an additional resource to transmit a resource reservation for an earliest resource of the set of resources, the selection of the additional resource based on a time interval between the additional resource and the earliest resource satisfying a time threshold, transmitting, via the additional resource, an IUE coordination message including an indication of the earliest resource within a first-stage SCI portion of the IUE coordination message, and receiving, from the second UE, a first sidelink message of the one or more sidelink messages within the earliest resource indicated via the first-stage SCI portion of the IUE coordination message.

An apparatus for wireless communication at a first UE is described. The apparatus may include a processor, memory coupled with the processor, and instructions stored in the memory. The instructions may be executable by the processor to cause the apparatus to select, from a resource pool for sidelink communications, a set of resources for one or more sidelink messages from a second UE to the first UE, select an additional resource to transmit a resource reservation for an earliest resource of the set of resources, the selection of the additional resource based on a time interval between the additional resource and the earliest resource satisfying a time threshold, transmit, via the additional resource, an IUE coordination message including an indication of the earliest resource within a first-stage SCI portion of the IUE coordination message, and receive, from the second UE, a first sidelink message of the one or more sidelink messages within the earliest resource indicated via the first-stage SCI portion of the IUE coordination message.

Another apparatus for wireless communication at a first UE is described. The apparatus may include means for selecting, from a resource pool for sidelink communications, a set of resources for one or more sidelink messages from a second UE to the first UE, means for selecting an additional resource to transmit a resource reservation for an earliest resource of the set of resources, the selection of the additional resource based on a time interval between the additional resource and the earliest resource satisfying a time threshold, means for transmitting, via the additional resource, an IUE coordination message including an indication of the earliest resource within a first-stage SCI portion of the IUE coordination message, and means for receiving, from the second UE, a first sidelink message of the one or more sidelink messages within the earliest resource indicated via the first-stage SCI portion of the IUE coordination message.

A non-transitory computer-readable medium storing code for wireless communication at a first UE is described. The code may include instructions executable by a processor to select, from a resource pool for sidelink communications, a set of resources for one or more sidelink messages from a second UE to the first UE, select an additional resource to transmit a resource reservation for an earliest resource of the set of resources, the selection of the additional resource based on a time interval between the additional resource and the earliest resource satisfying a time threshold, transmit, via the additional resource, an IUE coordination message including an indication of the earliest resource within a first-stage SCI portion of the IUE coordination message, and receive, from the second UE, a first sidelink message of the one or more sidelink messages within the earliest resource indicated via the first-stage SCI portion of the IUE coordination message.

Some examples of the method, apparatuses, and non-transitory computer-readable medium described herein may further include operations, features, means, or instructions for transmitting, to the second UE via a second-stage SCI portion of the IUE coordination message, a data portion of the IUE coordination message, or both, IUE coordination information including an indication of the set of resources for the one or more sidelink messages based on selecting the set of resources.

In some examples of the method, apparatuses, and non-transitory computer-readable medium described herein, the second-stage SCI portion, the data portion, or both, may be unable to be decoded by reduced-capability UEs and the indication of the earliest resource within the first-stage SCI portion may be capable of being decoded by reduced-capability UEs.

Some examples of the method, apparatuses, and non-transitory computer-readable medium described herein may further include operations, features, means, or instructions for transmitting a second IUE coordination message including a second indication of the earliest resource within a first-stage SCI portion of the second IUE coordination message, where the second IUE coordination message may be transmitted prior to the IUE coordination message and transmitting the IUE coordination message via the additional resource based on a second time interval between transmission of the second IUE coordination message and the earliest resource of the set of resources failing to satisfy the time threshold.

Some examples of the method, apparatuses, and non-transitory computer-readable medium described herein may further include operations, features, means, or instructions for transmitting, via the first-stage SCI portion of the IUE coordination message, an indication of a set of multiple subchannels of the earliest resource, where a last subchannel of the set of multiple subchannels may be within the resource pool in a frequency domain, where the first sidelink message may be transmitted via the set of multiple subchannels.

Some examples of the method, apparatuses, and non-transitory computer-readable medium described herein may further include operations, features, means, or instructions for transmitting, via the first-stage SCI portion of the IUE coordination message, one or more FDRI field values including an indication of a subchannel of the earliest resource, where the first sidelink message may be transmitted via at least the subchannel.

In some examples of the method, apparatuses, and non-transitory computer-readable medium described herein, the subchannel includes an initial subchannel of the earliest resource.

Some examples of the method, apparatuses, and non-transitory computer-readable medium described herein may further include operations, features, means, or instructions for transmitting, via the first-stage SCI portion of the IUE coordination message, one or more TDRI field values associated with the earliest resource, one or more FDRI field values associated with the earliest resource, or both.

Some examples of the method, apparatuses, and non-transitory computer-readable medium described herein may further include operations, features, means, or instructions for receiving, via the first sidelink message, an indication of a second resource of the set of resources and receiving, from the second UE, a second sidelink message via the second resource based on transmitting the indication of the second resource via the first sidelink message.

In some examples of the method, apparatuses, and non-transitory computer-readable medium described herein, the time interval satisfies the time threshold if the time interval may be less than or equal to the time threshold.

In some examples of the method, apparatuses, and non-transitory computer-readable medium described herein, the time threshold includes thirty-two slots.

Some examples of the method, apparatuses, and non-transitory computer-readable medium described herein may further include operations, features, means, or instructions for receiving a second IUE coordination message including an indication of a second resource for one or more additional sidelink messages to be performed by a second UE and relaying the second IUE coordination message to at least a third UE.

Some examples of the method, apparatuses, and non-transitory computer-readable medium described herein may further include operations, features, means, or instructions for receiving, via the second IUE coordination message, one or more TDRI field values associated with a relative timing of the one or more additional sidelink messages and transmitting, via the relayed second IUE coordination message, one or more additional TDRI field values associated with the relative timing of the one or more additional sidelink messages.

In some examples of the method, apparatuses, and non-transitory computer-readable medium described herein, the selection of the additional resource may be based on the time interval between the additional resource and the earliest resource being greater than or equal to a second time threshold associated with a processing capability of the first UE, the second UE, or both.

Some examples of the method, apparatuses, and non-transitory computer-readable medium described herein may further include operations, features, means, or instructions for selecting, from the resource pool for sidelink communications, a second set of resources for the one or more sidelink messages to be performed by the second UE, where selecting the second set of resources occurs prior to selecting the set of resources and determining that a second additional resource to transmit a resource reservation for an earliest resource of the second set of resources may be unable to be identified, where selecting the set of resources, selecting the additional resource, or both, may be based on determining that a second additional resource to transmit a resource reservation for an earliest resource of the second set of resources may be unable to be identified.

In some examples of the method, apparatuses, and non-transitory computer-readable medium described herein, the first-stage SCI portion of the IUE coordination message includes one or more bit field values which indicate that the first-stage SCI portion may be associated with the IUE coordination message.

A method for wireless communication at a second UE is described. The method may include receiving, from a first UE, an IUE coordination message including an indication of an earliest resource of a set of resources for one or more sidelink messages from the second UE to the first UE, the indication of the earliest resource included within a first-stage SCI portion of the IUE coordination message, the set of resources included within a resource pool for sidelink communications, where a time interval between reception of the SCI message and the earliest resource satisfies a time threshold and transmitting, a first sidelink message of the one or more sidelink messages within the earliest resource indicated via the first-stage SCI portion of the IUE coordination message.

An apparatus for wireless communication at a second UE is described. The apparatus may include a processor, memory coupled with the processor, and instructions stored in the memory. The instructions may be executable by the processor to cause the apparatus to receive, from a first UE, an IUE coordination message including an indication of an earliest resource of a set of resources for one or more sidelink messages from the second UE to the first UE, the indication of the earliest resource included within a first-stage SCI portion of the IUE coordination message, the set of resources included within a resource pool for sidelink communications, where a time interval between reception of the SCI message and the earliest resource satisfies a time threshold and transmit, a first sidelink message of the one or more sidelink messages within the earliest resource indicated via the first-stage SCI portion of the IUE coordination message.

Another apparatus for wireless communication at a second UE is described. The apparatus may include means for receiving, from a first UE, an IUE coordination message including an indication of an earliest resource of a set of resources for one or more sidelink messages from the second UE to the first UE, the indication of the earliest resource included within a first-stage SCI portion of the IUE coordination message, the set of resources included within a resource pool for sidelink communications, where a time interval between reception of the SCI message and the earliest resource satisfies a time threshold and means for transmitting, a first sidelink message of the one or more sidelink messages within the earliest resource indicated via the first-stage SCI portion of the IUE coordination message.

A non-transitory computer-readable medium storing code for wireless communication at a second UE is described. The code may include instructions executable by a processor to receive, from a first UE, an IUE coordination message including an indication of an earliest resource of a set of resources for one or more sidelink messages from the second UE to the first UE, the indication of the earliest resource included within a first-stage SCI portion of the IUE coordination message, the set of resources included within a resource pool for sidelink communications, where a time interval between reception of the SCI message and the earliest resource satisfies a time threshold and transmit, a first sidelink message of the one or more sidelink messages within the earliest resource indicated via the first-stage SCI portion of the IUE coordination message.

Some examples of the method, apparatuses, and non-transitory computer-readable medium described herein may further include operations, features, means, or instructions for receiving, from the first UE via a second-stage SCI portion of the IUE coordination message, a data portion of the IUE coordination message, or both, IUE coordination information including an indication of the set of resources for transmitting the one or more sidelink messages based on selecting the set of resources.

In some examples of the method, apparatuses, and non-transitory computer-readable medium described herein, the second-stage SCI portion, the data portion, or both, may be unable to be decoded by reduced-capability UEs and the indication of the earliest resource within the first-stage SCI portion may be capable of being decoded by reduced-capability UEs.

Some examples of the method, apparatuses, and non-transitory computer-readable medium described herein may further include operations, features, means, or instructions for receiving a second IUE coordination message including a second indication of the earliest resource within a first-stage SCI portion of the second IUE coordination message, where the second IUE coordination message may be transmitted prior to the IUE coordination message and receiving the IUE coordination message via the additional resource based on a second time interval between transmission of the second IUE coordination message and the earliest resource of the set of resources failing to satisfy the time threshold.

Some examples of the method, apparatuses, and non-transitory computer-readable medium described herein may further include operations, features, means, or instructions for receiving, via the first-stage SCI portion of the IUE coordination message, an indication of a set of multiple subchannels of the earliest resource, where a last subchannel of the set of multiple subchannels may be within the resource pool in a frequency domain, where the first sidelink message may be transmitted via the set of multiple subchannels.

Some examples of the method, apparatuses, and non-transitory computer-readable medium described herein may further include operations, features, means, or instructions for receiving, via the first-stage SCI portion of the IUE coordination message, one or more FDRI field values including an indication of a subchannel of the earliest resource, where the first sidelink message may be transmitted via at least the subchannel.

In some examples of the method, apparatuses, and non-transitory computer-readable medium described herein, the subchannel includes an initial subchannel of the earliest resource.

Some examples of the method, apparatuses, and non-transitory computer-readable medium described herein may further include operations, features, means, or instructions for receiving, via the first-stage SCI portion of the IUE coordination message, one or more TDRI field values associated with the earliest resource, one or more FDRI field values associated with the earliest resource, or both.

Some examples of the method, apparatuses, and non-transitory computer-readable medium described herein may further include operations, features, means, or instructions for transmitting, via the first sidelink message, an indication of a second resource of the set of resources and transmitting, from the second UE, a second sidelink message via the second resource based on transmitting the indication of the second resource via the first sidelink message.

In some examples of the method, apparatuses, and non-transitory computer-readable medium described herein, the time interval satisfies the time threshold if the time interval may be less than or equal to the time threshold.

In some examples of the method, apparatuses, and non-transitory computer-readable medium described herein, the time threshold includes thirty-two slots.

Some examples of the method, apparatuses, and non-transitory computer-readable medium described herein may further include operations, features, means, or instructions for relaying the IUE coordination message to at least a third UE.

Some examples of the method, apparatuses, and non-transitory computer-readable medium described herein may further include operations, features, means, or instructions for receiving, via the IUE coordination message, one or more TDRI field values associated with a relative timing of the one or more additional sidelink messages and transmitting, via the relayed IUE coordination message, one or more additional TDRI field values associated with the relative timing of the one or more additional sidelink messages.

In some examples of the method, apparatuses, and non-transitory computer-readable medium described herein, the first-stage SCI portion of the IUE coordination message includes one or more bit field values which indicate that the first-stage SCI portion may be associated with the IUE coordination message.

Some examples of the method, apparatuses, and non-transitory computer-readable medium described herein may further include operations, features, means, or instructions for performing one or more blind decoding procedures, where receiving the IUE coordination message may be based on performing the one or more blind decoding procedures.

Some examples of the method, apparatuses, and non-transitory computer-readable medium described herein may further include operations, features, means, or instructions for performing one or more decoding procedures for the IUE coordination message regardless of one or more parameters indicated via the inter-UE coordination message, the one or more parameters including a cast type, a destination identifier, a source identifier, feedback distance information, or any combination thereof.

### BRIEF DESCRIPTION OF THE DRAWINGS

FIG. 1 illustrates an example of a wireless communications system that supports techniques for backwards-compatible sidelink communications in accordance with aspects of the present disclosure.

FIG. 2 illustrates an example of a wireless communications system that supports techniques for backwards-compatible sidelink communications in accordance with aspects of the present disclosure.

FIG. 3 illustrates an example of a process flow that supports techniques for backwards-compatible sidelink communications in accordance with aspects of the present disclosure.

FIG. 4 illustrates an example of a process flow that supports techniques for backwards-compatible sidelink communications in accordance with aspects of the present disclosure.

FIGS. 5 and 6 show block diagrams of devices that support techniques for backwards-compatible sidelink communications in accordance with aspects of the present disclosure.

FIG. 7 shows a block diagram of a communications manager that supports techniques for backwards-compatible sidelink communications in accordance with aspects of the present disclosure.

FIG. 8 shows a diagram of a system including a device that supports techniques for backwards-compatible sidelink communications in accordance with aspects of the present disclosure.

FIGS. 9 through 12 show flowcharts illustrating methods that support techniques for backwards-compatible sidelink communications in accordance with aspects of the present disclosure.

### DETAILED DESCRIPTION

Some wireless communications systems may support sidelink communications between user equipments (UEs). In such systems, a base station may select resources for sidelink communications between UEs (e.g., “Mode 1” resource selection), or the UEs may autonomously select resources for sidelink communications (e.g., “Mode 2” resource selection). For Release 16 (Re16)UEs, all sidelink reservation information (e.g., indications of selected sidelink resources) may be conveyed via sidelink control information (SCI) messages (e.g., SCI-1). With SCI-1, a time gap between any two consecutive reserved resources may not exceed 32 slots (e.g., SCI-1 may only reserve resources 32 slots into the future). Comparatively, Release 17 (Re17) UEs may support IUE coordination messages to reserve sidelink resources, where the IUE coordination messages are not subject to timing restrictions (e.g., can reserve sidelink resources any quantity of slots in the future). However, Re16 UEs are not able to decode IUE coordination messages. The lack of backwards-compatibility with Re17 IUE coordination messages may result in increased interference, as Re16 UEs may not recognize resources which are reserved via IUE coordination messages, and may transmit over previously-reserved resources, resulting in interference.

Accordingly, aspects of the present disclosure are directed to techniques for scheduling sidelink communications for Re17 UEs which are backwards-compatible (e.g., understood) by Re16 UEs. In particular, techniques described herein enable Re17 UEs to transmit some sidelink scheduling information in an SCI-1 portion of IUE coordination messages (e.g., IUE messages) so that Re16 UEs are able to receive and recognize reservations of sidelink resources by Re17 UEs. For the purposes of the present disclosure, the terms “IUE coordination message” and “IUE message” may be used interchangeably, and may refer to sidelink messages which include control portions, such as a first-stage SCI portion (SCI-1 portion) and second-stage SCI portion (SCI-2 portion), as well as a data portion. The data portion of an IUE coordination message may include information to help other UEs select resources for sidelink communications (e.g., indications of preferred and/or non-preferred resources). What we are proposing is carrying reservation information in the SCI-1 portion of the IUE message.

For example, a UE (e.g., Re17 UE) may select a set of resources for sidelink messages which are to be performed by the UE or another UE. In some cases, the UE may transmit an IUE coordination message which reserves the set of resources, where some portions of the IUE coordination message (e.g., data portion, SCI-2 portion) are decodable by Re17 UEs, but not decodable by Re16 UEs. Additionally, the IUE coordination message may reserve the first resource (e.g., the earliest resource) of the selected set of resources in its SCI-1 portion. In other words, the UE may include an indication of the earliest selected resource in the SCI-1 portion of the IUE coordination message so that Re16 UEs are aware of the reservation of the earliest resource. Moreover, the UE may select the additional resource for transmitting the IUE coordination message to satisfy timing restrictions associated with the SCI-1 portion of the IUE coordination message. In other words, the UE may select the additional resource for transmitting the IUE coordination message such that the IUE coordination message is transmitted no more than 32 slots prior to the first selected resource. In this regard, the UE may transmit the IUE coordination message including an indication of the additional resource within the SCI-1 portion of the IUE coordination message such that Re16 UEs are aware of the reservation of the first/earliest resource.

Aspects of the disclosure are initially described in the context of wireless communications systems. Additional aspects of the disclosure are described in the context of example process flows. Aspects of the disclosure are further illustrated by and described with reference to apparatus diagrams, system diagrams, and flowcharts that relate to techniques for backwards-compatible sidelink communications.

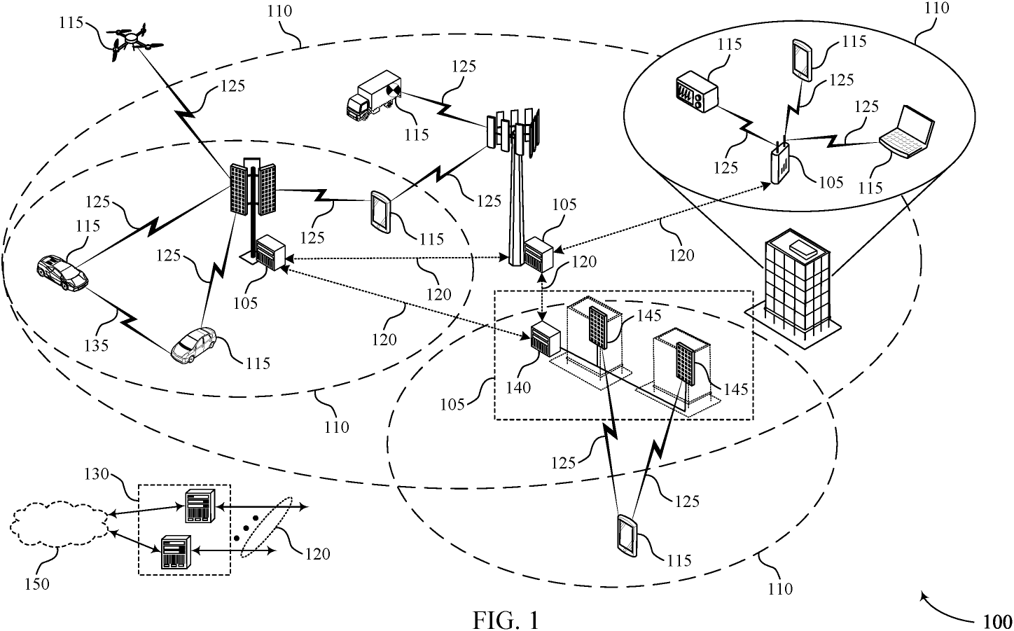

FIG. 1 illustrates an example of a wireless communications system 100 that supports techniques for backwards-compatible sidelink communications in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ = ⅟(Δƒₘₐₓ ▪ N_{ƒ} ) seconds, where Δƒₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., Nf) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The UEs 115 and the base stations 105 of the wireless communications system 100 may be configured to support techniques for selecting and reserving sidelink resources which may be understood by both reduced-capability UEs 115 (e.g., Re16 UEs) and non-reduced-capability UEs 115 (e.g., Re17 UEs 115). In this regard, the wireless communications system 200 may support techniques for scheduling sidelink communications for Re17 UEs 115 which are backwards-compatible (e.g., understood) by Re16 UEs 115. In particular, techniques described herein enable Re17 UEs 115 to transmit some sidelink scheduling information in a first-stage SCI portion (e.g., SCI-1 portion) of IUE coordination messages so that Re16 UEs 115 are able to receive and recognize reservations of sidelink resources by Re17 UEs 115. By enabling backwards compatibility in the context of scheduling sidelink communications, aspects of the present disclosure may improve coordination between UEs 115, thereby reducing interference and improving an efficiency and reliability of wireless communications.

For example, a UE 115 of the wireless communications system 100 (e.g., Re17 UE 115) may select a set of resources for sidelink messages which are to be performed by the UE 115 (e.g., self-scheduling, or self-reservation) or another UE 115. In some cases, the UE 115 may transmit an IUE coordination message which reserves the set of resources, where some portions of the IUE coordination message (e.g., SCI-2 portion, data portion) may be decoded by Re17 UEs 115, but not by Re16 UEs 115. Additionally, the IUE message may reserve the first resource (e.g., the earliest resource) of the selected set of resources via an indication within a first-stage SCI portion (e.g., SCI-1 portion) of the IUE coordination message. In particular, the UE 115 may select the additional resource for the IUE coordination message to satisfy timing restrictions associated with the SCI-1 portion such that the IUE coordination message (e.g., SCI-1 portion of the IUE coordination message) is transmitted no more than 32 slots prior to the first selected resource. Subsequently, the UE 115 may transmit the IUE coordination message within the additional resource, where the SCI-1 portion of the IUE coordination message is decodable by Re16 UEs 115 and indicates a reservation of the first/earliest reserved resource.

Techniques described herein may improve sidelink network coordination to reduce conflicts within sidelink resources. In particular, by transmitting some information related to reserved sidelink resources via an SCI-1 portion of IUE coordination messages, techniques described herein may enable backwards compatibility for sidelink reservations between Re17 and Re16 UEs 115. By enabling reservations of sidelink resources to be understood by both Re17 and Re16 UEs 115, techniques described herein may reduce potential conflicts within sidelink resources, and may enable more efficient and reliable communications within the wireless communications system 100.

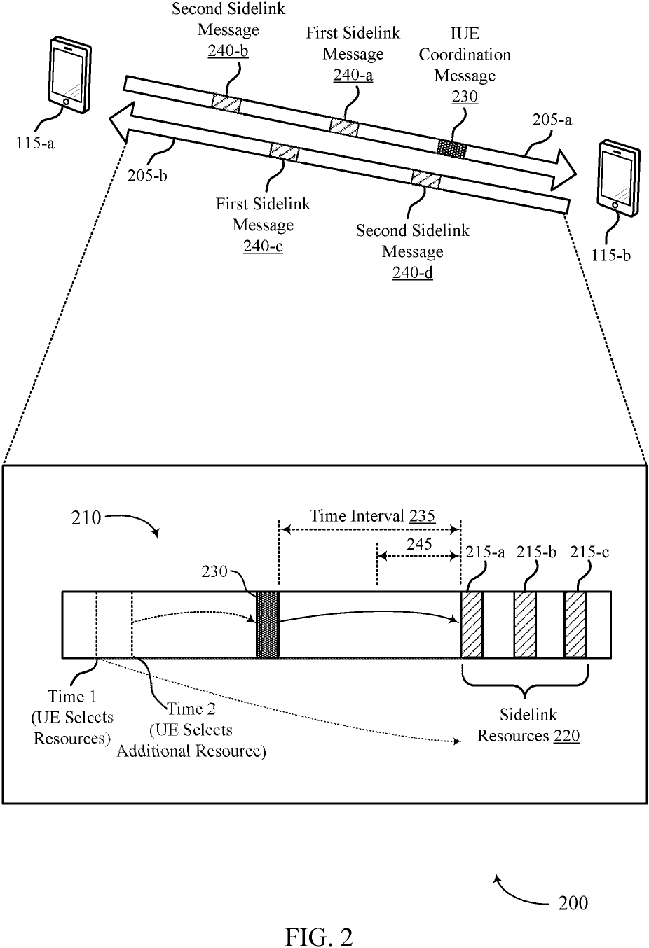

FIG. 2 illustrates an example of a wireless communications system 200 that supports techniques for backwards-compatible sidelink communications in accordance with aspects of the present disclosure. In some examples, wireless communications system 200 may implement, or be implemented by, aspects of wireless communications system 100. Wireless communications system 200 may support techniques for reserving sidelink resources which may be understood by UEs 115 of varying capabilities.

The wireless communications system 200 may include a base station 105 (not shown), a first UE 115-a, and a second UE 115-b, which may be examples of UEs 115, base stations 105, and other wireless devices as described with reference to FIG. 1. In some aspects, one or more of the UEs 115 may communicate with the base station 105 using communication links, which may be examples of an NR or LTE links between a base station 105 and the respective UE 115. In some aspects, communication links between a base station 105 and the respective UEs 115 may include examples of access links (e.g., Uu links) which may include bi-directional links that enable both uplink and downlink communication. Moreover, in some aspects, the first UE 115-a and the second UE 115-b may communicate with one another using a communication link 205, which may be an example of a sidelink communication link or PC5 link.

In some aspects, the communication link 205 between the respective UEs 115 (e.g., sidelink communication links) may be included within a sidelink network of the wireless communications system 200. The sidelink network (e.g., sidelink network including the communication links 205-a, 205-b) may be configured to operate in a “Mode 1” and/or a “Mode 2.” While operating in Mode 1, the sidelink network (e.g., communication link 205) may be managed (e.g., coordinated) by a base station 105. In this regard, during Mode 1 operation, a base station 105 may manage resource allocation over the communication link 205, and may allocate sets of resources within the communication link 205 to the respective UEs 115. In some cases, the base station 105 may allocate sets of sidelink resources to the respective UEs 115 during Mode 1 operation via RRC signaling, downlink control information (DCI) messages (e.g., DCI 3_0), or both. During Mode 1 operation, the base station 105-a may allocate sidelink resources via dynamic grants, configured grants (e.g., type 1 configured grants, type 2 configured grants), or both. Within Mode 1 operation, a modulation and coding scheme (MCS) used for communications over the communication link 210 (e.g., sidelink communication link) may be left up to the respective UEs 115, within limits which are pre-configured at the UEs 115 and/or signaled by the base station 105-a.

Comparatively, while operating in Mode 2, the sidelink network (e.g., communication link 205) may not be managed (e.g., may not be coordinated) by a base station 105. Without coordination or management of the resources of the sidelink network during the Mode 2 operation, the UEs 115 may be configured to monitor the sidelink network (e.g., monitor sidelink communication link 205 and/or other sidelink communication links), and determine sets of sidelink resources which are available for transmission of sidelink messages via the sidelink communication link 205. For example, the first UE 115-a may “autonomously” determine sidelink resources which are to be used within the communication link 205 by monitoring the a sidelink network including sidelink communication links, and decoding all physical sidelink control channels (PSCCH) and physical sidelink shared channels (PSSCHs) within the communication link 205 and sidelink network to identify sidelink resources which have been reserved by other UEs 115. Subsequently, the first UE 115-a may report available sidelink resources to the upper layer, and may transmit a sidelink control information (e.g., SCI) which reserves a set of sidelink resources for a sidelink communication to be performed (e.g., transmitted, received) at the first UE 115-a. In this regard, Mode 2 operation of the sidelink network including the communication link 205 may follow contention-based access procedures in which the various UEs 115 to “compete” for the use of the sidelink network, including the communication link 205.

Within Mode 2 sidelink operation, there are several different “types” of sidelink reservations which may be performed. For example, in accordance with an “IUE Coordination Scheme 1” (“Scheme 1”), the first UE 115-a may transmit, to the second UE 115-b, a set of resources which are preferred or not preferred for the second UEs 115-b sidelink message. In other words, coordination information which is communicated in Scheme 1 may include indications of preferred resources and/or non-preferred resources. In some cases, IUE coordination information may be communicated within a second-stage SCI portion (e.g., SCI-2 portion) of IUE coordination messages, a data portion of IUE coordination message, or both. The indication of the preferred/not preferred set of resources may be based on a sensing result of a sidelink network which was performed by the first UE 115-a, an expected or potential resource conflict, or any combination thereof. Some wireless communications systems may support techniques for down-selection between preferred resource sets and non-preferred resource sets in the context of Scheme 1.

Additionally, or alternatively, in accordance with an “IUE Coordination Scheme 2” (“Scheme 2”), the first UE 115-a may identify a resource conflict (e.g., within a set of sidelink resources), and may transmit an indication of the detected conflict to the second UE 115-b. For instance, the first UE 115-a may receive an SCI message from the second UE 115-b which reserves a set of sidelink resources for a sidelink message to be performed by the second UE 115-b, and may identify an expected or potential conflict on the reserved resources. In such cases, the first UE 115-a may transmit an indication of time/frequency resources for the detected conflict, a type of resource conflict, information associated with the sensing operation performed to detect the conflict, cast type information, and the like. In other words, coordination information which is communicated in Scheme 2 may include indications of past and/or future conflicts, which may be communicated within a second-stage SCI portion (e.g., SCI-2 portion) of IUE coordination messages, a data portion of IUE coordination message, or both. Some wireless communications systems may support techniques for down-selection between the expected/potential conflict and the detected resource conflict in the context of Scheme 1.

In some implementations, UEs 115 may be configured to implement Scheme 1 and Scheme 2 in different scenarios and/or when certain conditions or parameters are met. In other cases, the use of Scheme 1 and/or Scheme 2 may be configured via higher-layer signaling (e.g., RRC signaling, MAC-CE signaling), may be based on certain conditions or UE 115 capabilities. In other cases, signaling used in Scheme 1 and Scheme 2 may be limited to certain geographical scopes, such as among intended receivers within range of the respective UEs 115-a, 115-b. These signaling mechanisms within Mode 2 operation (e.g., signaling performed within Scheme 1 and Scheme 2) may help facilitate coordination between the UEs 115-a, 115-b (e.g., IUE coordination), which may improve an efficiency and reliability of wireless communications within a sidelink network of the wireless communications system 200.

When the second UE 115-b receives IUE coordination information from the first UE 115-a (e.g., indications of preferred/non-preferred conflicts in Scheme 1, indications of detected conflicts in Scheme 2), the second UE 115-b may utilize the received information in a variety of ways to improve sidelink reservations. For example, in the context of Scheme 1, the second UE 115-b may select or re-select which resources to use for its own sidelink message based on both a sensing result of the second UE 115-b (if available) and the received coordination information (e.g., the received indication of preferred/non-preferred resources). In other cases, the second UE 115-b may select or re-select which resources to use for its own sidelink message based only on the received coordination information, or may re-select resources based on the received coordination message. Comparatively, in the context of Scheme 1, the second UE 115-b may select or re-select which resources to use for its own sidelink message based on received indications of expected/potential conflicts, and/or may determine a necessity of retransmission based on the received indications of expected/potential conflicts.

Some wireless communications systems, such as the wireless communications systems 100 and 200, may support UEs 115 of differing capabilities, such as reduced-capability UEs 115 (e.g., Re16 UEs 115), and non-reduced-capability UEs 115 (e.g., Re17 UEs 115). In other words, Re16 UEs 115 and Re17 UEs 115 may coexist and communicate within the same resource pool. For example, in some cases, the first UE 115-a may include a non-reduced capability UE 115 (e.g., Re17 UE 115), and the second UE 115-b may include a reduced-capability UE 115 (e.g., Re16 UE 115). In other cases, both the first UE 115-a and the second UE 115-b may include nonreduced capability UEs 115.

However, UEs 115 with differing capabilities may utilize differing mechanisms for reserving and communicating over sidelink resources. Moreover, not all UEs 115 may be capable of receiving and decoding messages which reserve sidelink resources, which may result in increased interference.

For example, in the context of Re16, a Re16 UE 115 may select a set of sidelink resources 220 for its own sidelink messages at Time 1, as shown in FIG. 2. According to Re16 behavior, the UE 115 may not perform any other action until transmitting the first/earliest sidelink message within the earliest sidelink resource 215-a (e.g., first transmission of an aperiodic transmission, first semi-persistent scheduling (SPS) transmission) within the reserved set of sidelink resources 220. In other words, the Re 16 UE 115 may not transmit any indication of a reservation of the sidelink resources 220 after selecting the sidelink resources 220 at Time 1, such that the resources of the transmissions are selected but not signaled. This may result in interference when other UEs 115 reserve resources which overlap with the selected set of sidelink resources 220.

Comparatively, in the context of Re17, Re17 UEs 115 may signal resources which are selected for their own sidelink messages (e.g., self-reservation) and/or resources which are selected for sidelink messages to be performed by other UEs 115. For example, as noted previously herein, Re17 UEs 115 may reserve initial transmission resources as preferred or non-preferred resources by sending IUE coordination messages. Such IUE coordination information may be used by a UE 115 to schedule its own sidelink messages (e.g., self-reservation). In some aspects, a UE 115 may send a self-reservation in cases where the UE 115 has selected a resource, but has not yet signaled the reservation of the resource. In other cases, one UE 115 (or another wireless device) may select resources which are preferred/non-preferred for sidelink messages to be performed by another UE 115 (e.g., Tx UE 115), and may inform the Tx UE 115 of the preferred/non-preferred resources. Such indications of preferred/non-preferred resources may be distributed in which the Rx UE 115 schedules the Tx UE 115, or centralized, in which a scheduling UE 115 schedules a transmitting UE 115 (where the scheduling UE 115 may or may not be the UE 115 set to receive the sidelink message).

However, not all UEs 115 may be capable of receiving and decoding IUE coordination messages which reserve sidelink resources. In particular, Re16 UEs 115 are not able to decode or understand the content of IUE coordination messages used by Re17 UEs 115. As such, in cases where Re17 UEs 115 coordinate with one another regarding reserved sidelink resources, Re16 UEs 115 may be unaware of such coordination, and may transmit on resources which were previously reserved by Re17 UEs 115. In other words, Re16 sidelink communications may collide with Re17 sidelink communications despite Re17 IUE coordination. This results in increases interference which degrades a performance of both Re16 and Re17 communications.

Accordingly, aspects of the present disclosure are directed to techniques for scheduling sidelink communications for Re17 UEs which are backwards-compatible (e.g., understood) by Re16 UEs. Aspects of the present disclosure are directed to signaling and other configurations which enable Re16 UEs 115 to be aware of intended Re17 sidelink communications, which may affect several parameters of Re17 used to indicate sidelink reservations via IUE coordination information, including the IUE coordination container, the IUE coordination signaling design, and the IUE coordination procedure. Moreover, aspects of the present disclosure may enable Re16 UEs 115 to understand reservations of sidelink resources for initial transmissions as preferred/nonpreferred resources (e.g., self-scheduling), as well as signaling in which a scheduling Re17 UE 115 schedules and/or recommends resources for a different, scheduled Re17 UE 115.

In particular, techniques described herein enable Re17 UEs to transmit some sidelink control information in an SCI-1 portion of IUE coordination messages (e.g., first-stage SCI) so that Re16 UEs are able to receive and recognize reservations of sidelink resources by Re17 UEs. As noted previously herein, SCI-1 is the only form of resource reservations which may be understood (e.g., decoded) by some Re16 UEs 115. Further, with SCI-1, a time gap between any two consecutive reserved resources may not exceed 32 slots (e.g., SCI-1 may only reserve resources 32 slots into the future). Accordingly, in some implementations, aspects of the present disclosure may enable Re17 sidelink reservations which are transmitted via an SCI-1 portion of IUE coordination messages to adhere to the SCI-1 reservation time gap limit, to the extent possible. In other words, aspects of the present disclosure may enable Re17 UEs 115 to transmit some sidelink reservation information vis SCI-1 portions of IUE coordination messages, where time gaps between the SCI-1 portion of the respective IUE coordination message and/or time gaps between consecutive resources reserved via the SCI-1 portion of the IUE coordination message is less than 32 slots.

For example, in the context of self-scheduling where the first UE 115-a reserves initial transmission resources (e.g., non-preferred resources) for its own sidelink messages 240, the first UE 115-a may be configured to select a set of sidelink resources 220 for its own sidelink messages 240. For instance, as shown in FIG. 2, the first UE 115-a may select a set of sidelink resources 220 for sidelink messages 240 from the first UE 115-a to the second UE 115-b at Time 1. The first UE 115-a may additionally be configured to select an additional resource which will be used to transmit an IUE coordination message 230 which indicates a reservation of a first resource (e.g., earliest resource) of the set of sidelink resources 220 within a first-stage SCI portion (e.g., SCI-1 portion) of the IUE coordination message 230. In other words, at Time 2, the first UE 115-a may select an additional resource which will be used to transmit an IUE coordination message 230 which reserves the earliest sidelink resource 215-a of the set of sidelink resources 220 via the SCI-1 portion of the IUE coordination message 230.

When selecting the additional resource which will be used to transmit the IUE coordination message 230 that reserves the earliest sidelink resource 215-a (e.g., indicates the non-preferred resources), the first UE 115-a may be configured to select the additional resource such that the additional resource satisfies timing requirements for the SCI-1 portion of the IUE coordination message 230. In other words, the first UE 115-a may be configured to select the additional resource for the IUE coordination message 230 such that the earliest sidelink resource 215-a is less than 32 slots after the additional resource for sending the IUE coordination message 230 including the nonpreferred resource indication.

In this regard, the first UE 115-a may select the additional resource for the IUE coordination message 230 such that a time interval 235 between the additional resource (e.g., additional resource for the IUE coordination message 230) and the earliest sidelink resource 215-a satisfies a time threshold. More specifically, the first UE 115-a may select the additional resource for the IUE coordination message 230 such that a time interval 235 between the additional resource (e.g., additional resource for the IUE coordination message 230) and the earliest sidelink resource 215-a is less than 32 slots (e.g., time interval 235 between the SCI-1 portion of the IUE coordination message 230 and the earliest sidelink resource 215-a is less than 32 slots).

In some aspects, the second UE 115-b may attempt to decode the IUE coordination message 230 regardless of one or more parameters indicated via SCI (e.g., SCI-1 portion, SCI-2 portion, or both) of the IUE coordination message 230, such as cast type, a destination identifier, a source identifier, feedback distance information, and the like. In particular, in cases where the second UE 115-b identifies the IUE coordination message 230 as an IUE message (e.g., via one or more bit fields of the IUE coordination message 230, or via restriction), the second UE 115-b may attempt to decode the IUE coordination message 230 regardless of cast type, destination identifier information, source identifier information, and/or feedback distance information indicated via the SCI (e.g., SCI-1 portion and/or SCI-2 portion) of the IUE coordination message 230. By attempting to decode the IUE coordination message regardless of these parameters, techniques described herein may enable each UE 115 within the wireless communications system 200 to receive the IUE coordination message 230 as broadcasted information, even in cases where the IUE coordination message 230 is piggybacked to data and therefor shares the same cast type characteristic with the data.

There are several implementations which may be implemented by the first UE 115-a such that the additional resource for the IUE coordination message 230 satisfies timing requirements for SCI-1 messages (e.g., timing requirement for the SCI-1 portion of the IUE coordination message 230). For example, in some cases, the first UE 115-a may repeat R16 resource selection procedures multiple times until the earliest sidelink resource 215-a is less than 32 slots from the additional resource selected to send the non-preferred resource indication (e.g., less than 32 slots from the additional resource for the IUE coordination message 230). By way of another example, the first UE 115-a may exhaustively search for all possible combinations of resources selected to send the non-preferred resource indication and the earliest sidelink resource 215-a, and may then uniformly sample each respective resource combination which satisfies the 32 slot time constraint.

In some cases, if the first UE 115-a is unable to find/select an additional resource for the IUE coordination message 230 which satisfies the timing constraints for SCI-1 signaling, the first UE 115-a may wait to transmit the scheduled sidelink messages 240 (e.g., may select a new set of sidelink resources 220). Additionally, or alternatively, if the first UE 115-a is unable to find/select an additional resource for the IUE coordination message 230 which satisfies the timing constraints for SCI-1 signaling, the first UE 115-a may refrain from reserving the earliest sidelink resource 215-a and/or including IUE coordination information within the IUE coordination message 230, as will be discussed in further detail herein. However, it is noted herein that the 32-slot time constraint for SCI-1 signaling may not be an absolute requirement (e.g., may not be binding). As such, the first UE 115-a may perform reasonable searching to select the additional resource which will satisfy the time constraint, but is not required to do so in all circumstances. For example, in cases with high volumes of sidelink traffic, there may not be any available resources for the IUE coordination message 230 which may be selected to satisfy the SCI-1 timing constraints.

After selecting the additional resource for the IUE coordination message 230 (e.g., the additional resource which will be used to transmit the indication of the earliest sidelink resource 215-a) at Time 2, the first UE 115-a may transmit the IUE coordination message 230 within the selected additional resource. For example, the first UE 115-a may select the additional resource at Time 2, and may subsequently transmit an IUE coordination message via the additional resource. In some aspects, the IUE message 230 may include an indication of the earliest sidelink resource 215-a of the set of selected sidelink resources 220.

In some cases, the first UE 115-a may be configured to transmit multiple IUE coordination message s 230 in order to satisfy the SCI-1 timing constraints. In particular, if the additional selected resource for the IUE coordination message 230 does not satisfy the 32-slot time constraint (e.g., if time interval 235 is greater than 32 slots), the first UE 115-a may “daisy chain” multiple IUE coordination messages 230 until one of the IUE coordination messages 230 satisfies 32-slot timing constraint. In other words, the first UE 115-a may select/schedule extra resources to send non-preferred resource indication (e.g., select extra resources for sending additional IUE coordination messages 230) if the initial gap (time interval 235) between the additional resource selected to send the IUE coordination message 230 and the earliest sidelink resource 215-a is too large (e.g., greater than 32 slots). For example, if the time interval 235 between the earliest sidelink resource 215-a and the SCI-1 portion of the IUE coordination message 230 is greater than 32 slots, the first UE 115-a may transmit additional IUE coordination messages 230 which reserve the earliest sidelink resource 215-a until a time interval between an SCI-1 portion of a transmitted IUE coordination message 230 satisfies the time constraint (e.g., until an SCI-1 portion of a transmitted IUE coordination message 230 is less than 32 slots before the earliest sidelink resource 215-a).

By way of another example, the first UE 115-a may perform a resource selection procedure to select the resource for transmitting the IUE coordination message 230. If the earliest sidelink resource 215-a for the sidelink messages 240 is less than 32 + T slots away from the resource selected for the IUE coordination message 230, the UE 115-a may trigger another resource selection procedure in order to find another resource for the IUE coordination message 230 which will satisfy the applicable timing constraints (e.g., another resource within 32 slots of the earliest sidelink resource 215a). Comparatively, if earliest sidelink resource 215-a for the sidelink messages 240 is more than 32 + T slots away from the resource selected for the IUE coordination message 230, the UE 115-a may wait until 32 + T slots before the earliest sidelink resource 215-a to trigger another resource selection procedure in order to find another resource for the IUE coordination message before the earliest sidelink resource 215-a. In other words, the UE 115-a may start resource selection at 32 + T slots prior to the earliest sidelink resource 215-a, and may seek to select a resource for the IUE coordination message 230 which is within 32 slots of the earliest sidelink resource 215a. In these examples, T may indicate a period of time or additional time interval (e.g., one or more slots, symbols, etc.) to account for resource selection, implementation, and processing constraints at the first UE 115-a and/or the second UE 115-b. The value of T may be configured via the network (e.g., via RRC signaling), pre-configured at the UE 115-a, or may be left up to UE 115 implementation. Moreover, the value of T may be bounded by an upper bound Tₘₐₓ, where Tₘₐₓ may be pre-configured, configured or signaled via the network (e.g., via RRC signaling, SIB broadcasting), pre-configured at the UE 115-a, or may be left up to UE 115 implementation.

In cases where the earliest sidelink resource 215-a is less than 32 slots from the additional resource used to transmit the IUE coordination message 230 including the non-preferred resource indication, the IUE coordination message 230 may include an indication of the earliest sidelink resource 215-a. In other words, in cases where the timing constraint (e.g., 32-slot timing constraint) is satisfied, the SCI-1 portion of the IUE coordination message 230 may reserve the earliest sidelink resource 215-a. In such cases, the IUE coordination message 230 (e.g., SCI-1 portion of the IUE coordination message 230) may include an indication of a set of subchannels for the earliest sidelink resource 215-a. The quantity of reserved subchannels may indicate the quantity of subchannels for the earliest sidelink resource 215-a which will be sued to transmit data (e.g., which will be used to transmit a first/earliest sidelink message 240-a). However, in some cases, this indication may be unexpected (e.g., may be regarded as “cheating”) to R16 UEs 115, as non-preferred resource indication messages for Re16 UEs 115 may only one subchannel. However, the impact is negligible. The indication of subchannels for the earliest sidelink resource 215-a may not have any impact on sidelink resource selection, as reserved resources in the current slot are not used as an input for resources selection procedures, and resource selection procedures (e.g., resource selection algorithms) only use future resources for resource selection determining resource selections. Further, the indication of subchannels for the earliest sidelink resource 215-a may have a limited impact on demodulation procedures at the second UE 115-b, as the second UE 115-b may not attempt to decode data after failing to decode SCI-2.

On the other hand, a Re17 UE may need to know that the IUE coordination message 230 is only 1 subchannel, even though the SCI-1 portion of the IUE coordination message 230 indicates that the message is more than one subchannel, otherwise such Re17 UEs 115 may be unable to decode the SCI-2 portion and the corresponding data portion of the IUE coordination message 230 to recover the rest of the IUE coordination information (other than the initial reserved resource). In some aspects, the resource(s) used to transmit IUE coordination messages 230 may be restricted to some fixed time and/or fixed frequency location (e.g., resources which are pre-configured or indicated via control signaling). For example, the IUE coordination message 230 may be transmitted via a single subchannel. In this regard, by transmitting IUE coordination messages 230 within fixed time/frequency resources (e.g., via a single subchannel), Re17 UEs 115 may be configured to identify that signals received within the respective resources may be associated with a potential IUE coordination message 230, and may therefore attempt to decode SCI-2 on a single subchannel. In additional or alternative implementations, Re17 UEs 115 may be configured to perform blind decoding procedures to decode SCI-2 on the single subchannel (e.g., blind decoding for the SCI-2 portion of the IUE coordination message 230). In such cases, if a Re17 UE 115 decodes a valid SCI-2 payload, the Re17 UE 115 will know that it is a potential IUE coordination message 230. Moreover, in some cases, a reserved bit in SCI-1 payload (e.g., reserved bit(s) within the SCI-1 portion of the IUE coordination message 230) may be used to indicate that this is an IUE coordination message 230 so that Re17 UEs 115 may attempt to decode SCI-2 in one subchannel (e.g., decode the SCI-2 portion of the IUE coordination message 230 within one subchannel).

If the indicated end (last, final) subchannel for the earliest sidelink resource 215-a and/or the last subchannel of the non-preferred resource indication message is out of a resource pool for sidelink communications, some UEs 115 (e.g., Re16 UEs 115) may be unable to interpret the reserved subchannels, and may therefore disregard the reservation information. In other words, a last subchannel used to transmit the IUE coordination message 230 and the last subchannel of the reserved earliest sidelink resource 215-a must be positioned within a resource pool for sidelink communications in order for some Re16 UEs 115 to understand the reservation. Accordingly, in cases where the IUE coordination message 230 indicates a set of subchannels for the earliest sidelink resource 215-a, the last subchannel of the set of subchannels may be within the resource pool for sidelink communications in the frequency domain. In some implementations, this constraint may cause the first UE 115-a to transmit the IUE coordination message 230 within a resource which is far from an end of the resource pool (e.g., within resource 0 of the resource pool in the frequency domain).

In other cases, the IUE coordination message 230 may indicate/reserve a single subchannel for the earliest sidelink resource 215-a. In such cases, the quantity of reserved subchannels for the earliest sidelink resource 215-a would be one, and may be included within the resource pool for sidelink communications. Reserving a single subchannel may be expected by R16 UEs 115 (e.g., “non-cheating” option), and there may be no restriction as to where in the frequency domain of the resource pool that the IUE coordination message 230 may be transmitted. However, by indicating only a single subchannel for the earliest sidelink resource 215-a, the full sidelink message 240-a which will be transmitted within the earliest sidelink resource 215-a may not be reserved or protected. That is, only a portion of the data transmission which is transmitted within the single indicated subchannel may be reserved/protected.

In some cases, a frequency domain resource indication (FDRI) field within the SCI-1 portion of the IUE coordination message 230 may point to (e.g., indicate) the first/initial subchannel of the earliest sidelink resource 215-a (e.g., first/initial subchannel of the first sidelink message 240-a which will be transmitted via the earliest sidelink resource 215-a). By indicating the first/initial subchannel, techniques described herein may at least protect the first subchannel of the sidelink message 240-a where SCI-1 will be carried. In some cases, SCI-2 may be transmit across multiple subchannels. Additionally, or alternatively, the FDRI field within the IUE coordination message 230 may point to (e.g., indicate) any subchannel of the earliest sidelink resource 215-a (e.g., any subchannel of the first sidelink message 240-a which will be transmitted via the earliest sidelink resource 215-a). In some aspects, whether the first UE 115-a indicates the first/initial subchannel or any subchannel of the earliest sidelink resource 215-a may be left up to UE 115-a implementation, may be indicated to the first UE 115 via the network, or both.

In some aspects, the first UE 115-a may transmit an indication of reserved resources (e.g., indication of sidelink resources 220) on both an IUE coordination message 230 and duplicated via the corresponding SCI-1 portion of the IUE coordination message 230, assuming the SCI-1 timing constraint is satisfied. In other words, when the IUE coordination message 230 (e.g., SCI-1 portion of the IUE coordination message 230) is transmitted less than 32 slots from the earliest sidelink resources 215-a, the first UE 115-a may transmit an indication of the earliest sidelink resource via the SCI-1 portion of the IUE coordination message 230, and at the same time include the earliest sidelink resource in the non preferred set of resource indicated in IUE coordination information included within the IUE coordination message 230 (e.g., IUE coordination information included within the SCI-2 and/or data portion of the IUE coordination message 230). Comparatively, if the timing constraint is not satisfied, the first UE 115-a may transmit an indication of the earliest sidelink resource in the non-preferred set of resource indicated in an IUE coordination message without reservation via SCI-1 (e.g., indication within the SCI-2 portion and/or data portion, but not in the SCI-1 portion). In other words, if the IUE coordination message 230 (e.g., SCI-1 portion of the IUE coordination message 230) is transmitted more than 32 slots from the earliest sidelink resources 215-a, the first UE 115-a may transmit an indication of non-preferred resources via IUE coordination message, and without SCI-1 duplication.

In additional or alternative implementations, the first UE 115-a may transmit an indication of reserved resources (e.g., indication of sidelink resources 220) via the SCI-1 portion of the IUE coordination message 230 only (e.g., no duplication). In such cases, if the SCI-1 portion of the IUE coordination message 230 is transmitted more than 32 slots from the earliest sidelink resources 215-a, the first UE 115-a may be configured to refrain from transmitting the reservation of the earliest sidelink resource 215-a (e.g., fallback to Re16 behavior), or wait until a later time when it is possible to transmit an IUE coordination message 230 reserving the initial sidelink resource 215-a which satisfies the timing constraint.

In some cases, the UEs 115 of the wireless communications system 200 may be configured to forward, or relay, IUE coordination messages 230 and other messages which reserve sidelink resources to other UEs 115. By forwarding/relaying the initial resource reservation in the IUE coordination messages 230 to other UEs 115 within the wireless communications system 200, techniques described herein may enable receiver-side protection for the scheduled sidelink messages 240, particularly in the context of unicast links. For example, upon receiving the IUE coordination message 230 which reserves the earliest sidelink resource 215-a, the second UE 115-b may forward, or relay, the initial resource reservation in the IUE coordination message 230 to other UEs 115, such as UEs 115 which are out of range from the first UE 115-a. Relaying the initial resource reservation (e.g., SCI-1 portion) in the IUE coordination message 230 may enable other UEs 115 to become aware of the reserved sidelink resources 220, which may further reduce interference and conflict within the wireless communications system 200. In such cases, the UE 115-b may be configured to relay the entirety of the IUE coordination message 230 and/or only the portion of the IUE coordination message 230 which indicates the reservation of the earliest sidelink resource 215-a (e.g., only the SCI-1 portion of the IUE coordination message 230). The first UE 115-a may be similarly configured to forward/relay initial resource reservations in the IUE coordination messages 230 and other resource reservations the first UE 115-a receives to other wireless devices within the wireless communications system 200.

In cases where a UE 115 of the wireless communications system 200 forwards/relays initial resource reservation in the IUE coordination messages 230 and other signaling used to reserve sidelink resources, time domain resource indication (TDRI) fields within the SCI-1 portion of the IUE coordination message 230 may be repackaged, or reset, to point to the same relative timing of the reserved resources. In other words, TDRI fields may be reset to account for a time difference between a first time when the IUE coordination message 230 was originally transmitted, and a second time when the initial resource reservation in the IUE coordination message 230 was relayed. For example, the IUE coordination message 230 transmitted by the first UE 115-a may include a TDRI field which indicates a time difference (e.g., time gap) between transmission of the IUE coordination message 230 and the earliest sidelink resource 215-a. Upon receiving the IUE coordination message 230, the second UE 115-b may relay the initial resource reservation in the IUE coordination message 230 to other UEs 115 (e.g., relay the entire IUE coordination message 230 and/or the SCI-1 portion of the IUE coordination message 230), and may re-package (e.g., reset) the TDRI field within the relayed IUE coordination message 230 such that the TDRI field points to the relative timing of the same earliest sidelink resource 215-a. In other words, the second UE 115-b may reset the TDRI field within the relayed IUE coordination message 230 such that the reset TDRI field indicates a time gap between the time at which the relaying IUE coordination message 230 and a time of the same earliest sidelink resource 215-a. Moreover, the SCI-2 portion and/or data portion of the relaying IUE coordination message 230 may or may not include duplicate indications of the reserved resources, as described previously herein, depending on whether the IUE coordination message 230 which was originally transmitted by the first UE 115-a includes duplicate indications within the respective SCI-2/data portions.

Subsequently, the first UE 115-a may transmit a first sidelink message 240-a via the earliest sidelink resource 215-a which was indicated via the IUE coordination message 230. In some cases, the first sidelink message 240-a may indicate time/frequency resources for a subsequent sidelink message 240. For example, in some cases, the first sidelink message 240-a may include time/frequency resources for a subsequent sidelink resource 215-b which will be used to transmit a second sidelink message 240-b. For instance, the first sidelink message 240-a may include SCI-1 and/or SCI-2 which schedules the subsequent (second) sidelink message 240-b. Similarly, the second sidelink message 240-b may indicate time/frequency resources for a subsequent sidelink message 240 (e.g., indicate time/frequency resources for sidelink resource 215-c).

In addition to supporting backwards-compatible sidelink reservations in the context of self-reservation (e.g., self-scheduling by indicating non-preferred resources), techniques of the present disclosure may also be used for backwards-compatible signaling for scheduling/recommending resources for another UE 115. In other words, techniques described herein may be used in cases where the first UE 115-a schedules sidelink messages 240 which are to be performed by the second UE 115-b.

For example, the first UE 115-a may be configured to select a set of sidelink resources 220 for sidelink messages 240 which are to be performed/transmitted by the second UE 115-b. In this regard, the first UE 115-a (e.g., scheduling UE 115-a) may select resources which will be used by the second UE 115-b (e.g., scheduled UE 115-b) for transmitting sidelink messages 240-a and/or 240-b. For instance, as shown in FIG. 2, the first UE 115-a may select a set of sidelink resources 220 for sidelink messages 240 from the second UE 115-b to the first UE 115-a (or another UE 115) at Time 1. The first UE 115-a may additionally be configured to select an additional resource which will be used to transmit an IUE coordination message 230 (e.g., SCI-1 portion of the IUE coordination message 230) which indicates a reservation of a first resource (e.g., earliest resource) of the set of sidelink resources 220. In other words, at Time 2, the first UE 115-a may select an additional resource which will be used to transmit an IUE coordination message 230 which reserves the earliest sidelink resource 215-a of the set of sidelink resources 220 within an SCI-1 portion of the IUE coordination message 230, as described previously herein.

As noted previously herein in the context of reserving non-preferred resources for self-selection, the first UE 115-a may be configured to select the additional resource which will be used to reserve the earliest sidelink resource 215-a such that the additional resource satisfies timing requirements for SCI-1. In other words, the first UE 115-a may be configured to select the additional resource for the IUE coordination message 230 such that the earliest sidelink resource 215-a is less than (or equal to) 32 slots after the additional resource for sending the IUE coordination message 230 including the non-preferred resource indication.

Further, the first UE 115-a may require a certain amount of time (e.g., time interval 245, T slots) between transmission of the IUE coordination message 230 and receiving the earliest IUE coordination message 230 for processing and handshaking. The amount of time required for the first UE 115-a for processing and handshaking may depend on how the handshaking procedure is designed. As such, in some cases, the first UE 115-a may select the additional resource for transmitting the resource reservation in such a manner as to satisfy an additional time interval 245 (e.g., T slots) associated with a processing capability at the first UE 115-a and/or handshaking procedures to be performed between the first UE 115-a and the second UE 115-b. The additional time interval 245 for processing and handshaking may be satisfied if the IUE coordination message 230 is transmitted more than T slots prior to the earliest sidelink resource. Accordingly, the first UE 115-f may select the additional resource for transmitting the resource reservation such that the additional resource is more than T slots prior to the earliest sidelink resource, but less than 32 slots prior to the earliest sidelink resource (e.g., T ≤ Time_{SCI} ≤ 32).

There are several implementations which may be implemented by the first UE 115-a such that the additional resource for the IUE coordination message 230 satisfies timing requirements for SCI-1 messages, and the additional time interval 245 for processing and handshaking. For example, in some cases, the first UE 115-a may repeat R16 resource selection procedures multiple times until the earliest sidelink resource 215-a is less than 32 slots, but more than T slots, from the additional resource selected to send the non-preferred resource indication (e.g., less than 32 slots, but greater than T slots of the time interval 245 from the additional resource for the IUE coordination message 230), and more than T slots. By way of another example, the first UE 115-a may exhaustively search for all possible combinations of resources selected to send the non-preferred resource indication and the earliest sidelink resource 215-a, and may then uniformly sample each respective resource combination which satisfies the 32 slot time constraint and the additional time interval 245.

As described previously herein, the first UE 115-a may be configured to send reserved resource information via the IUE coordination message 230 (e.g., via the SCI-1 portion of the IUE coordination message 230), via IUE coordination information included within the SCI-2 and/or data portion of the IUE coordination message 230, or both, based on whether certain conditions are met. As such, any discussion associated with techniques used for self-reservation may also be applied to cases in which the first UE 115-a schedules/recommends resources for the second UE 115-b, unless noted otherwise herein.

After selecting the additional resource for the IUE coordination message 230 (e.g., the additional resource which will be used to transmit the indication of the earliest sidelink resource 215-a) at Time 2, the first UE 115-a may transmit the IUE coordination message 230 within the selected additional resource. For example, the first UE 115-a may select the additional resource at Time 2, and may subsequently transmit an IUE coordination message 230 via the additional resource. In some aspects, the SCI1 portion of the IUE coordination message 230 may include an indication of the earliest sidelink resource 215-a of the set of selected sidelink resources 220. Moreover, as described previously herein, the first UE 115-a may be configured to transmit multiple IUE coordination messages 230 (e.g., daisy-chain IUE coordination messages 230) in cases where a previously transmitted IUE coordination message 230 fails to satisfy one or more time thresholds or time constraints.

Subsequently, the second UE 115-b may transmit a first sidelink message 240-c via the earliest sidelink resource 215-a which was indicated via the IUE coordination message 230. In some cases, the first sidelink message 240-c may indicate time/frequency resources for a subsequent sidelink message 240. For example, in some cases, the first sidelink message 240-c may include time/frequency resources for a subsequent sidelink resource 215-b which will be used to transmit a second sidelink message 240-d. For instance, the first sidelink message 240-c may include SCI-1 and/or SCI-2 which schedules the subsequent (second) sidelink message 240-d which will be performed by the second UE 115-d. Similarly, the second sidelink message 240-d may indicate time/frequency resources for a subsequent sidelink message 240 (e.g., indicate time/frequency resources for sidelink resource 215-c).

Techniques described herein may improve sidelink network coordination to reduce conflicts within sidelink resources. In particular, by transmitting some information related to reserved sidelink resources via first-stage SCI portions (e.g., SCI1 portion) of IUE coordination messages, techniques described herein may enable backwards compatibility for sidelink reservations between Re17 and Re16 UEs 115. By enabling reservations of sidelink resources to be understood by both Re17 and Re16 UEs 115, techniques described herein may reduce potential conflicts within sidelink resources, and may enable more efficient and reliable communications within the wireless communications system 100.

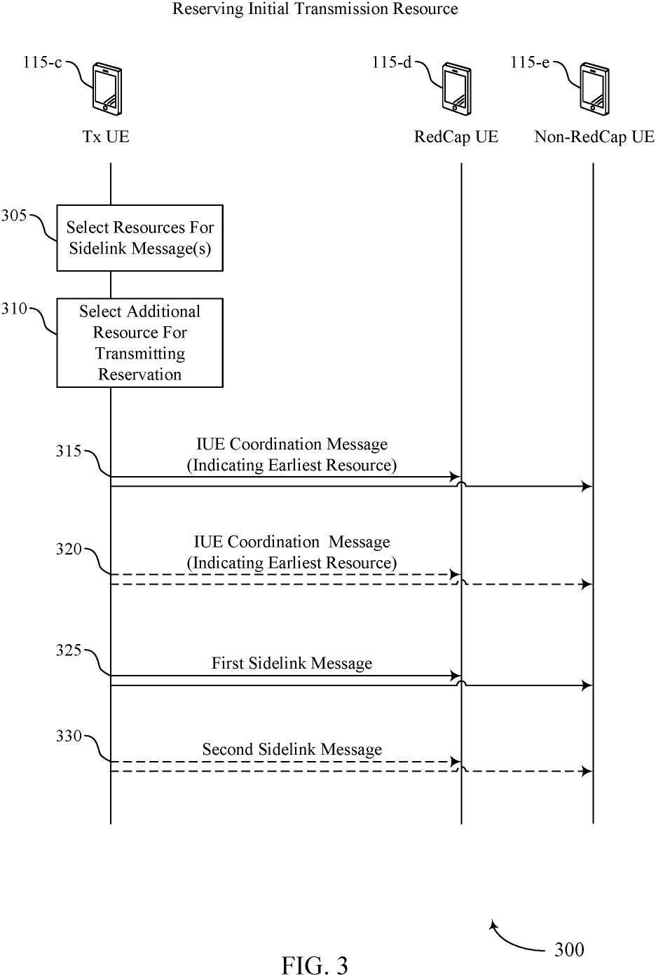

FIG. 3 illustrates an example of a process flow 300 that supports techniques for backwards-compatible sidelink communications in accordance with aspects of the present disclosure. In some examples, process flow 300 may implement, or be implemented by, aspects of wireless communications systems 100, wireless communications systems 200, or both. For example, the process flow 300 may illustrate a first UE 115-c selecting resources for its own sidelink messages, selecting an additional resource for transmitting an IUE coordination message for reserving the earliest reserved resource, and transmitting the SCI to reserve the earliest reserved resource, as described with reference to FIGS. 1-2.

In some cases, process flow 300 may include a first UE 115-c, a second UE 115-d, and a third UE 115-e, which may be examples of corresponding devices as described herein. For example, the first UE 115-c and the second UE 115-d illustrated in FIG. 3 may include examples of the first UE 115-a and the second UE 115-b, respectively, as illustrated in FIG. 2. The first UE 115-c may include a UE 115 which is reserving resources for its own sidelink messages (e.g., performing self-reservation). Moreover, in some cases, the first UE 115-c may include a non-reduced capability UE 115 (e.g., Re 17 UE 115). In some implementations, the second UE 115-d may include a reduced-capability UE 115 (e.g., Re16 UE 115), and the third UE 115-e may include a non-reduced capability UE 115 (e.g., Re17 UE 115).

In some examples, the operations illustrated in process flow 300 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 305, the first UE 115-c may select a set of resources for one or more sidelink messages to be performed by the first UE 115-c (e.g., self-scheduling). The first UE 115-c may select the set of resources from a resource pool for sidelink communications. For example, as shown in FIG. 2, the first UE 115-c may select a set of sidelink resources 220 for sidelink messages 240 to be performed by the first UE 115-c.

At 310, the first UE 115-c may select an additional resource for transmitting a resource reservation for an earliest resource of the set of resources selected at 305. For example, as shown in FIG. 2, the first UE 115-c may select an additional resource which will be used to transmit an IUE coordination message which indicates a resource reservation of the earliest sidelink resource 215-a of the set of selected sidelink resources 220 (e.g., via a first-stage SCI portion of the IUE coordination message).

In some aspects, the first UE 115-c may select the additional resource for transmitting the resource reservation such that a time interval between the additional resource and the earliest resource satisfies a time threshold. For example, as shown in FIG. 2, the first UE 115-c may select the additional resource for transmitting the SCI-1 such that a time interval 235 between the additional resource and the earliest sidelink resource 215-a satisfies a time threshold. In some cases, the time threshold may include 32 slots, and the time interval (e.g., time interval 235) may satisfy the time threshold if the time interval is less than or equal to the time threshold (e.g., time threshold satisfied if time interval 235 ≤ 32 slots).

At 315, the first UE 115-c may transmit an IUE coordination message. In some aspects, the IUE coordination message may include an indication of the earliest resource of the set of resources which were selected at 305. In particular, the IUE coordination message may include a first-stage SCI portion (e.g., SCI-1 portion) which indicates/reserves the earliest resource of the set of resources which were selected at 305. Moreover, the IUE coordination message may be transmitted within the additional resource which was selected at 310. For example, as shown in FIG. 2, the IUE coordination message transmitted at 315 may include an indication of the earliest sidelink resource 215-a of the set of sidelink resources 220.

In some aspects, the indication of the earliest sidelink resource within the IUE coordination message transmitted at 315 may be capable of being decoded by nonreduced capability UEs 115 and reduced-capability UEs 115. In other words, the SCI-1 portion of the IUE coordination message which reserves the earliest resource may be decodable by both non-reduced capability UEs 115 and reduced-capability UEs 115. For example, the SCI-1 portion of the IUE coordination message may be able to be decoded by both the second UE 115-d (e.g., Re16 UE 115-d) and the third UE 115-e (e.g., Re17 UE 115-d).

In some aspects, the IUE coordination message may include IUE coordination information which includes an indication of the set of resources which were selected at 305. For example, as shown in FIG. 2, the IUE coordination message may include an indication of the set of sidelink resources within a second-stage SCI portion (e.g., SCI-2 portion) and/or data portion of the IUE coordination message. As compared to the indication of the earliest resource which is capable of being decoded by both non-reduced capability UEs 115 and reduced-capability UEs 115, the IUE coordination information may not be able to be decoded by reduced-capability UEs 115. In other words, the SCI-2 portion and/or data portion of the IUE coordination message may be unable to be decoded by reduced-capability UEs 115. For example, in some cases, the IUE coordination information (e.g., the indication of the set of resources selected at 305) may be unable to be decoded by the second UE 115-d (e.g., the Re16 UE 115-d).

In some aspects, the IUE coordination message may indicate time/frequency resources of the earliest resource. In particular, the SCI-1 portion of the IUE coordination message may indicate time/frequency resources of the earliest resources. Time and frequency resources associated with the earliest resource may be indicated via FDRI field values, TDRI field values, or both. In some aspects, the IUE coordination message may include an indication of a set of subchannels of the earliest resource. For example, as shown in FIG. 2, the SCI-1 portion of the IUE coordination message may include an indication of a set of subchannels for the earliest sidelink resource 215-a. In some aspects, a last subchannel of the set of subchannels may be included within the resource pool for the sidelink communications in the frequency domain. In particular as described herein, Re16 UEs 115 may be unable to understand/decode the IUE coordination message if the last indicated subchannel is outside of the resource pool for sidelink communications. As such, by ensuring that the last subchannel is within the resource pool, techniques described herein may ensure that Re16 UEs 115 are able to decode the IUE coordination message. In additional or alternative implementations, the IUE coordination message may indicate a single subchannel of the earliest resource. For example, as shown in FIG. 2, the SCI-1 portion of the IUE coordination message may include one or more FDRI field values which indicate a subchannel (e.g., first/initial subchannel) of the earliest sidelink resource 215-a.

In some implementations, the UEs 115-c, 115-d, and 115-e may be configured to forward, or relay, IUE coordination messages and other communications which schedule/reserve sidelink resources. The UEs 115 may be configured to forward/relay the entirety of received IUE coordination messages, and/or only portions of received IUE coordination messages which indicate earliest reserved resources, such as the SCI-1 portions. For example, in some cases, the second UE 115-d and the third UE 115-e may be configured to forward, or relay, the received IUE coordination message to other UEs 115 within the wireless communications system. By forwarding/relaying IUE coordination messages 230 to other UEs 115 within the wireless communications system 200, techniques described herein may enable receiver-side protection for the scheduled sidelink messages 240, particularly in the context of unicast links. In some implementations, upon forwarding/relaying the received IUE coordination message to other UEs 115, the second UE 115-d and/or third UE 115-e may be configured to re-package, or reset, TDRI fields within the relayed IUE coordination message to point to the same relative timing of the reserved resources. In other words, TDRI fields may be reset to account for a time difference between a first time when the IUE coordination message was originally transmitted by the first UE 115-c, and a second time when the IUE coordination message was relayed by the respective UE 115-c, 115-d. The first UE 115-c may be similarly configured to forward/relay IUE coordination messages and other resource reservations the first UE 115-c receives to other wireless devices within the wireless communications system.

In some implementations, as described previously herein, the first UE 115-c may be configured to transmit multiple IUE coordination messages in cases where a previously-transmitted IUE coordination message does not satisfy a time threshold (e.g., does not satisfy the 32-slot time constraint). Accordingly, in cases where the SCI-1 portion of the IUE coordination message transmitted at 315 does not satisfy the time threshold (e.g., in cases where the SCI-1 portion of the IUE coordination message at 315 is transmitted more than 32 slots before the earliest resource), the process flow 300 may proceed to 320. Otherwise, in cases where the IUE coordination message transmitted at 315 does satisfy the time threshold (e.g., in cases where the SCI-1 portion of the IUE coordination message at 315 is transmitted less than 32 slots before the earliest resource), the process flow 300 may proceed to 325.

At 320, the first UE 115-c may transmit an additional IUE coordination message, where the additional IUE coordination message includes an indication of the earliest resource of the set of resources which were selected at 305 (e.g., within an SCI1 portion of the additional IUE coordination message). In particular, the first UE 115-c may transmit the additional IUE coordination message at 320 in order to bridge a gap between the IUE coordination message at 315 and the earliest resource such that a time interval (e.g., time interval 235) between the additional IUE coordination message at 320 and the earliest sidelink resource satisfies the time threshold. In other words, the first UE 115-c may transmit the additional IUE coordination message at 320 based on a time interval between the SCI-1 portion of the IUE coordination message at 315 and the earliest sidelink resource failing to satisfy the time threshold. In this regard, any description associated with the IUE coordination message at 315 may be understood to apply to the IUE coordination message at 320.

At 325, the first UE 115-c may transmit a first sidelink message within the earliest resource which was indicated via the IUE coordination message at 320 and/or 325 (e.g., via the SCI-1 portions of the respective IUE coordination messages). For example, as shown in FIG. 2, the first UE 115-c may transmit a first sidelink message 240-a (e.g., sidelink data message) via the earliest sidelink resource 215-a. In some cases, the first sidelink message at 325 may indicate time/frequency resources for a subsequent sidelink message. For example, in some cases, the first sidelink message at 325 may indicate time/frequency resources for a second sidelink message which will be performed at 330. For example, the first sidelink message at 325 may include SCI-1 and/or SCI-2 which schedules the subsequent (second) sidelink message at 330.

At 330, the first UE 115-c may transmit a second sidelink message within a second resource which was selected at 305. For example, as shown in FIG. 2, the first UE 115-c may transmit a second sidelink message 240-b (e.g., sidelink data message) within the second sidelink resource 215-b of the set of sidelink resources 220. Moreover, as described with reference to the first sidelink message at 325, the second sidelink message at 330 may indicate time/frequency resources for a subsequent sidelink message.

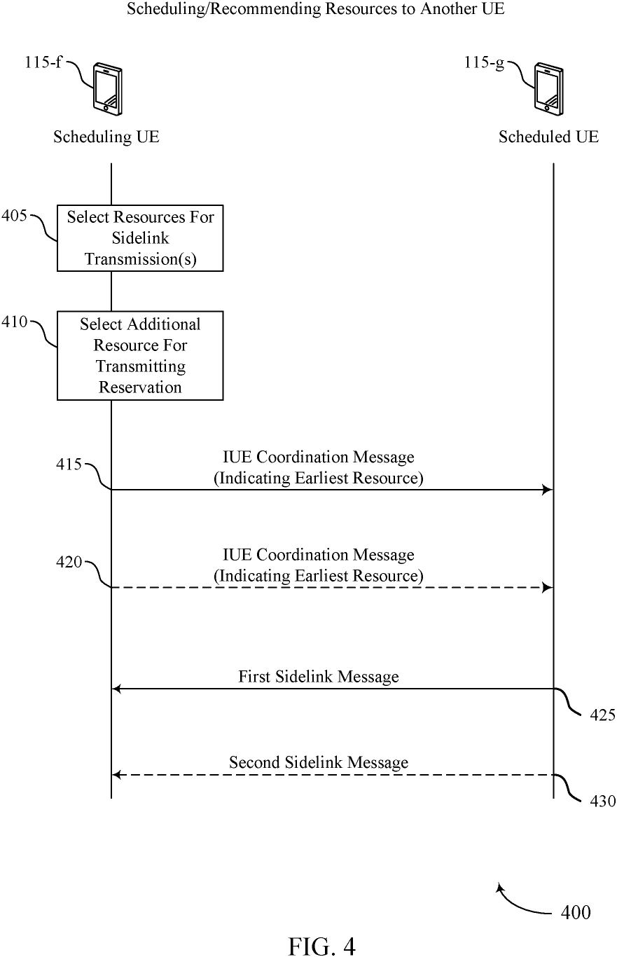

FIG. 4 illustrates an example of a process flow 400 that supports techniques for backwards-compatible sidelink communications in accordance with aspects of the present disclosure. In some examples, process flow 400 may implement, or be implemented by, aspects of wireless communications systems 100, wireless communications systems 200, or both. For example, the process flow 400 may illustrate a first UE 115-f (e.g., scheduling UE 115-1) selecting resources for sidelink messages to be performed/transmitted by a second UE 115 (e.g., scheduled UE 115-g), selecting an additional resource for transmitting an IUE coordination message for reserving the earliest reserved resource, and transmitting the SCI to reserve the earliest reserved resource, as described with reference to FIGS. 1-3.

In some cases, process flow 400 may include a first UE 115-g and a second UE 115-g, which may be examples of corresponding devices as described herein. For example, the first UE 115-f and the second UE 115-g illustrated in FIG. 4 may include examples of the first UE 115-a and the second UE 115-b, respectively, as illustrated in FIG. 2. The first UE 115-c may include a scheduling UE 115-f which schedules/recommends resources for sidelink messages to be performed by the second, scheduled UE 115-g. In some cases, the first UE 115-f may include a non-reduced capability UE 115 (e.g., Re 17 UE 115). Moreover, the second UE 115-g may include a reduced-capability UE 115 (e.g., Re16 UE 115) or a non-reduced capability UE 115 (e.g., Re17 UE 115).

In some examples, the operations illustrated in process flow 400 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 405, the first UE 115-f may select a set of resources for one or more sidelink messages to be performed by the second UE 115-g (e.g., non-self-scheduling). The first UE 115-fmay select the set of resources from a resource pool for sidelink communications. For example, as shown in FIG. 2, the first UE 115-f may select a set of sidelink resources 220 for sidelink messages 240 to be performed by the second UE 115-g.

At 410, the first UE 115-f may select an additional resource for transmitting a resource reservation for an earliest resource of the set of resources selected at 405. For example, as shown in FIG. 2, the first UE 115-f may select an additional resource which will be used to transmit an IUE coordination message which indicates a resource reservation of the earliest sidelink resource 215-a of the set of selected sidelink resources 220 within an SCI-1 portion of the IUE coordination message.

In some aspects, the first UE 115-f may select the additional resource for transmitting the resource reservation such that a time interval between the additional resource and the earliest resource satisfies a time threshold. For example, as shown in FIG. 2, the first UE 115-f may select the additional resource for transmitting the IUE coordination message such that a time interval 235 between the additional resource and the earliest sidelink resource 215-a satisfies a time threshold. In particular, the first UE 115-f may select the additional resource for transmitting the IUE coordination message such that a time interval 235 between the SCI-1 portion of the IUE coordination message 230 and the earliest sidelink resource 215-a satisfies a time threshold. In some cases, the time threshold may include 32 slots, and the time interval (e.g., time interval 235) may satisfy the time threshold if the time interval is less than or equal to the time threshold (e.g., time threshold satisfied if time interval 235 ≤ 32 slots).

In some implementations, the first UE 115-f may require a certain amount of time between transmission of the IUE coordination message and receiving the earliest IUE coordination message for processing and handshaking. As such, as shown in FIG. 2, the first UE 115-f may select the additional resource for transmitting the resource reservation in such a manner as to satisfy an additional time interval 245 (e.g., T slots) associated with a processing capability at the first UE 115-f and/or handshaking procedures to be performed between the first UE 115-f and the second UE 115-g. The additional time interval for processing and handshaking may be satisfied if the SCI message is transmitted more than T slots prior to the earliest sidelink resource. Accordingly, the first UE 115-f may select the additional resource for transmitting the resource reservation such that the additional resource is more than T slots prior to the earliest sidelink resource, but less than 32 slots prior to the earliest sidelink resource (e.g., T ≤ Time_{SCI} ≤ 32).

At 415, the first UE 115-f may transmit an SCI message. In some aspects, the IUE coordination message may include an indication of the earliest resource of the set of resources which were selected at 405. In particular, a first-stage SCI portion (e.g., SCI-1 portion) of the IUE coordination message may include an indication of the earliest resource of the set of resources which were selected at 405. Moreover, the IUE coordination message may be transmitted within the additional resource which was selected at 410. For example, as shown in FIG. 2, the SCI-1 portion of the IUE coordination message transmitted at 415 may include an indication of the earliest sidelink resource 215-a of the set of sidelink resources 220.

In some aspects, the indication of the earliest sidelink resource within the IUE coordination message transmitted at 415 may be capable of being decoded by nonreduced capability UEs 115 and reduced-capability UEs 115. In other words, the SCI-1 portion of the IUE coordination message which indicates the earliest reserved resource may be decoded by both non-reduced capability UEs 115 and reduced-capability UEs 115. For example, the SCI-1 portion of the IUE coordination message may be able to be decoded by both the second UE 115-g (e.g., Re16 UE 115-g) and the third UE 115-e (e.g., Re17 UE 115-g). In some aspects, the IUE coordination message may include IUE coordination information which includes an indication of the set of resources which were selected at 405. In particular, the IUE coordination information may include additional IUE coordination information within a second-stage SCI portion (e.g., SCI-2 portion) and/or data portion of the IUE coordination message. For example, as shown in FIG. 2, the IUE coordination message may include an indication of the set of sidelink resources within an SCI-2 and/or data portion of the IUE coordination message 230. As compared to the indication of the earliest resource indicated via the SCI-1 portion which is capable of being decoded by both non-reduced capability UEs 115 and reduced-capability UEs 115, the IUE coordination information indicated via the SCI-2 and/or data portions may not be able to be decoded by reduced-capability UEs 115. For example, in some cases, the IUE coordination information (e.g., the indication of the set of resources selected at 405) indicated via an SCI-2 and/or data portion of the IUE coordination message may be unable to be decoded by the second UE 115-g (e.g., the Re16 UE 115-g).

In some aspects, the IUE coordination message may indicate time/frequency resources of the earliest resource. In particular, the SCI-1 portion of the IUE coordination message may indicate time/frequency resources of the earliest resource. Time and frequency resources associated with the earliest resource may be indicated via FDRI field values, TDRI field values, or both, as descried with reference to FIGS. 1-3. Moreover, as described previously herein, the UEs 115-f and 115-g may be configured to forward, or relay, IUE coordination messages and other communications which schedule/reserve sidelink resources for receiver-side protection.

In some implementations, as described previously herein, the first UE 115-f may be configured to transmit multiple IUE coordination messages in cases where a previously-transmitted IUE coordination message does not satisfy a time threshold (e.g., does not satisfy the 32-slot time constraint). Accordingly, in cases where the IUE coordination message transmitted at 415 does not satisfy the time threshold (e.g., in cases where the SCI-1 portion of the IUE coordination message at 415 is transmitted more than 32 slots before the earliest resource), the process flow 400 may proceed to 420. Otherwise, in cases where the IUE coordination message transmitted at 415 does satisfy the time threshold (e.g., in cases where the SCI-1 portion of the IUE coordination message at 415 is transmitted less than 32 slots before the earliest resource), the process flow 400 may proceed to 425.

At 420, the first UE 115-f may transmit an additional IUE coordination message, where the additional IUE coordination message includes an indication of the earliest resource of the set of resources which were selected at 405 (e.g., within a SCI-1 portion of the additional IUE coordination message). In particular, the first UE 115-f may transmit the additional IUE coordination message at 420 in order to bridge a gap between the IUE coordination message at 415 and the earliest resource such that a time interval (e.g., time interval 245) between the additional IUE coordination message at 420 and the earliest sidelink resource satisfies the time threshold. In other words, the first UE 115-f may transmit the additional IUE coordination message at 420 based on a time interval between the IUE coordination message at 415 and the earliest sidelink resource failing to satisfy the time threshold. In this regard, any description associated with the IUE coordination message at 415 may be understood to apply to the SCI message at 420.

At 425, the second UE 115-g may transmit a first sidelink message within the earliest resource which was indicated via the SCI-1 portion of the IUE coordination message at 420 and/or 425. For example, as shown in FIG. 2, the second UE 115-g may transmit a first sidelink message 240-c (e.g., sidelink data message) via the earliest sidelink resource 215-a. The second UE 115-g may transmit the first sidelink message at 425 to the first UE 115-f and/or additional UEs 115.

In some cases, the first sidelink message at 425 may indicate time/frequency resources for a subsequent sidelink message. For example, in some cases, the first sidelink message at 425 may indicate time/frequency resources for a second sidelink message which will be performed at 430. For example, the first sidelink message at 425 may include SCI-1 and/or SCI-2 which schedules the subsequent (second) sidelink message at 430.

At 430, the second UE 115-g may transmit a second sidelink message within a second resource which was selected at 405. For example, as shown in FIG. 2, the second UE 115-g may transmit a second sidelink message 240-d (e.g., sidelink data message) within the second sidelink resource 215-b of the set of sidelink resources 220. Moreover, as described with reference to the first sidelink message at 425, the second sidelink message at 430 may indicate time/frequency resources for a subsequent sidelink message.

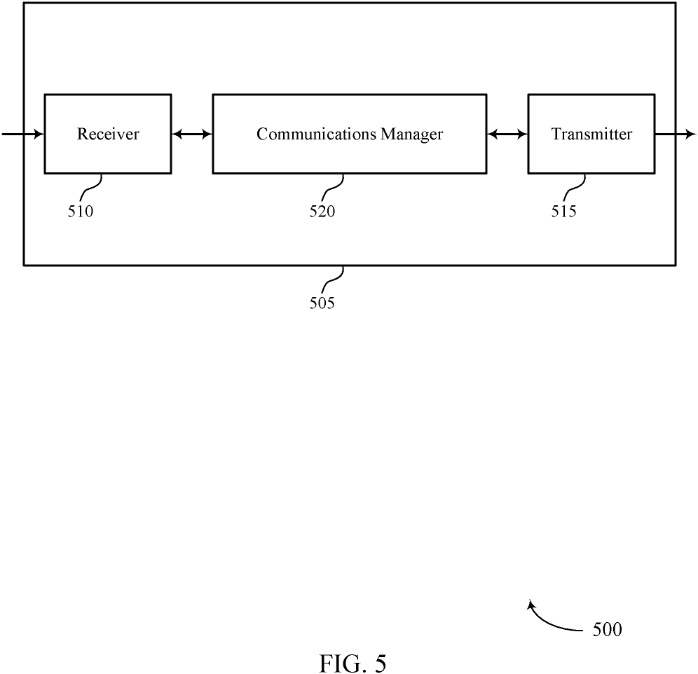

FIG. 5 shows a block diagram 500 of a device 505 that supports techniques for backwards-compatible sidelink communications in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for backwards-compatible sidelink communications ). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for backwards-compatible sidelink communications ). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for backwards-compatible sidelink communications as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. For example, the communications manager 520 may be configured as or otherwise support a means for selecting, from a resource pool for sidelink communications, a set of resources for one or more sidelink messages to be performed by the UE. The communications manager 520 may be configured as or otherwise support a means for selecting an additional resource to transmit a resource reservation for an earliest resource of the set of resources, the selection of the additional resource based on a time interval between the additional resource and the earliest resource satisfying a time threshold. The communications manager 520 may be configured as or otherwise support a means for transmitting, via the additional resource, an IUE coordination message including an indication of the earliest resource within a first-stage SCI portion of the IUE coordination message. The communications manager 520 may be configured as or otherwise support a means for transmitting a first sidelink message of the one or more sidelink messages within the earliest resource indicated via the first-stage SCI portion of the IUE coordination message.

Additionally or alternatively, the communications manager 520 may support wireless communication at a first UE in accordance with examples as disclosed herein. For example, the communications manager 520 may be configured as or otherwise support a means for selecting, from a resource pool for sidelink communications, a set of resources for one or more sidelink messages from a second UE to the first UE. The communications manager 520 may be configured as or otherwise support a means for selecting an additional resource to transmit a resource reservation for an earliest resource of the set of resources, the selection of the additional resource based on a time interval between the additional resource and the earliest resource satisfying a time threshold. The communications manager 520 may be configured as or otherwise support a means for transmitting, via the additional resource, an IUE coordination message including an indication of the earliest resource within a first-stage SCI portion of the IUE coordination message. The communications manager 520 may be configured as or otherwise support a means for receiving, from the second UE, a first sidelink message of the one or more sidelink messages within the earliest resource indicated via the first-stage SCI portion of the IUE coordination message.

Additionally or alternatively, the communications manager 520 may support wireless communication at a second UE in accordance with examples as disclosed herein. For example, the communications manager 520 may be configured as or otherwise support a means for receiving, from a first UE, an IUE coordination message including an indication of an earliest resource of a set of resources for one or more sidelink messages from the second UE to the first UE, the indication of the earliest resource included within a first-stage SCI portion of the IUE coordination message, the set of resources included within a resource pool for sidelink communications, where a time interval between reception of the SCI message and the earliest resource satisfies a time threshold. The communications manager 520 may be configured as or otherwise support a means for transmitting, a first sidelink message of the one or more sidelink messages within the earliest resource indicated via the first-stage SCI portion of the IUE coordination message.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for backwards-compatible sidelink reservations to improve sidelink network coordination and reduce conflicts within sidelink resources. In particular, by transmitting some information related to reserved sidelink resources via SCI messages, techniques described herein may enable backwards compatibility for sidelink reservations between Re17 and Re16 UEs 115. By enabling reservations of sidelink resources to be understood by both Re17 and Re16 UEs 115, techniques described herein may reduce potential conflicts within sidelink resources, and may enable more efficient and reliable communications within the wireless communications system 100.

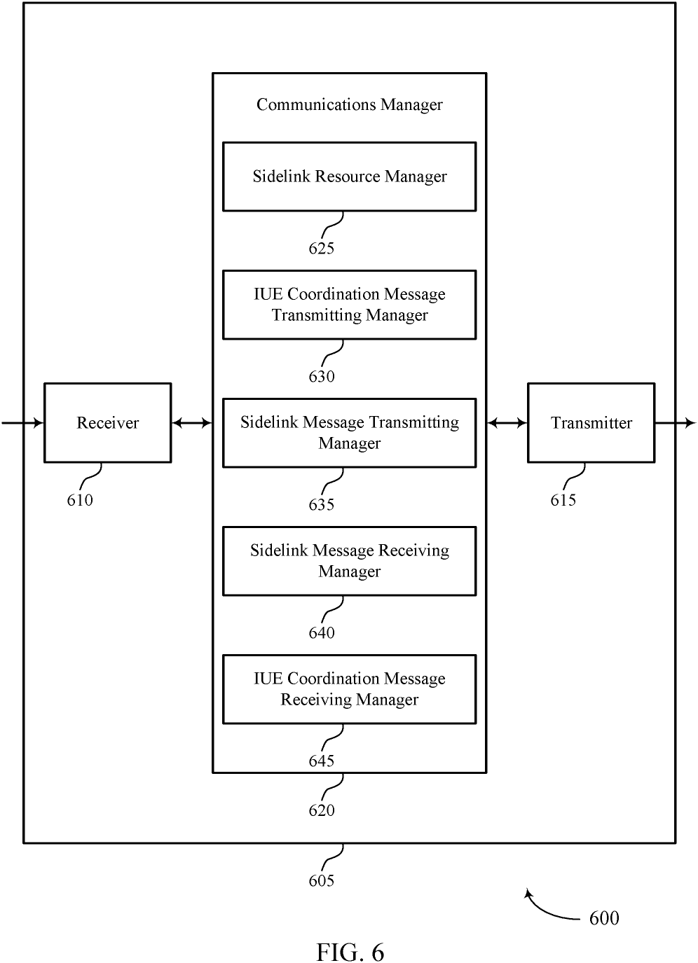

FIG. 6 shows a block diagram 600 of a device 605 that supports techniques for backwards-compatible sidelink communications in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for backwards-compatible sidelink communications ). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for backwards-compatible sidelink communications ). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for backwards-compatible sidelink communications as described herein. For example, the communications manager 620 may include a sidelink resource manager 625, an IUE coordination message transmitting manager 630, a sidelink message transmitting manager 635, a sidelink message receiving manager 640, an IUE coordination message receiving manager 645, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. The sidelink resource manager 625 may be configured as or otherwise support a means for selecting, from a resource pool for sidelink communications, a set of resources for one or more sidelink messages to be performed by the UE. The sidelink resource manager 625 may be configured as or otherwise support a means for selecting an additional resource to transmit a resource reservation for an earliest resource of the set of resources, the selection of the additional resource based on a time interval between the additional resource and the earliest resource satisfying a time threshold. The IUE coordination message transmitting manager 630 may be configured as or otherwise support a means for transmitting, via the additional resource, an IUE coordination message including an indication of the earliest resource within a first-stage SCI portion of the IUE coordination message. The sidelink message transmitting manager 635 may be configured as or otherwise support a means for transmitting a first sidelink message of the one or more sidelink messages within the earliest resource indicated via the first-stage SCI portion of the IUE coordination message.

Additionally or alternatively, the communications manager 620 may support wireless communication at a first UE in accordance with examples as disclosed herein. The sidelink resource manager 625 may be configured as or otherwise support a means for selecting, from a resource pool for sidelink communications, a set of resources for one or more sidelink messages from a second UE to the first UE. The sidelink resource manager 625 may be configured as or otherwise support a means for selecting an additional resource to transmit a resource reservation for an earliest resource of the set of resources, the selection of the additional resource based on a time interval between the additional resource and the earliest resource satisfying a time threshold. The IUE coordination message transmitting manager 630 may be configured as or otherwise support a means for transmitting, via the additional resource, an IUE coordination message including an indication of the earliest resource within a first-stage SCI portion of the IUE coordination message. The sidelink message receiving manager 640 may be configured as or otherwise support a means for receiving, from the second UE, a first sidelink message of the one or more sidelink messages within the earliest resource indicated via the first-stage SCI portion of the IUE coordination message.

Additionally or alternatively, the communications manager 620 may support wireless communication at a second UE in accordance with examples as disclosed herein. The IUE coordination message receiving manager 645 may be configured as or otherwise support a means for receiving, from a first UE, an IUE coordination message including an indication of an earliest resource of a set of resources for one or more sidelink messages from the second UE to the first UE, the indication of the earliest resource included within a first-stage SCI portion of the IUE coordination message, the set of resources included within a resource pool for sidelink communications, where a time interval between reception of the SCI message and the earliest resource satisfies a time threshold. The sidelink message transmitting manager 635 may be configured as or otherwise support a means for transmitting, a first sidelink message of the one or more sidelink messages within the earliest resource indicated via the first-stage SCI portion of the IUE coordination message.

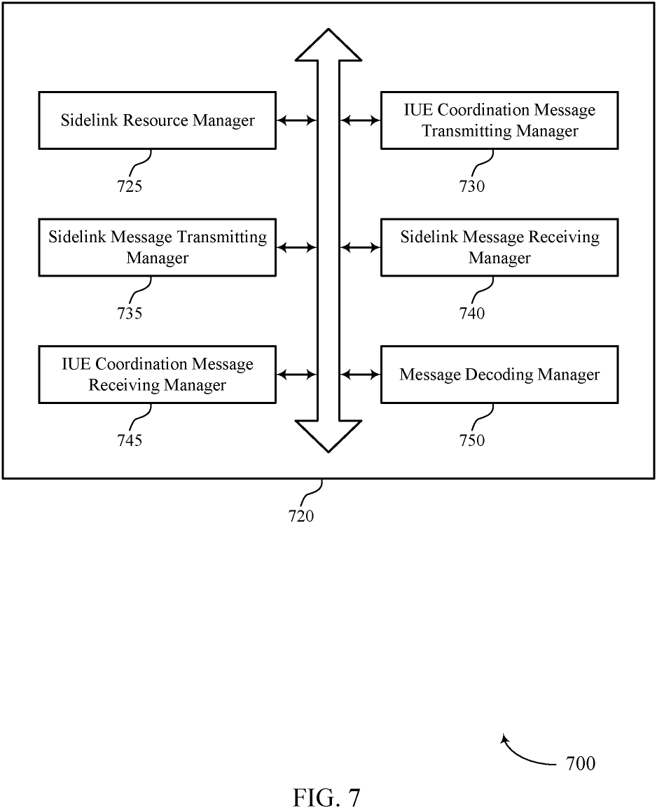

FIG. 7 shows a block diagram 700 of a communications manager 720 that supports techniques for backwards-compatible sidelink communications in accordance with aspects of the present disclosure. The communications manager 720 may be an example of aspects of a communications manager 520, a communications manager 620, or both, as described herein. The communications manager 720, or various components thereof, may be an example of means for performing various aspects of techniques for backwards-compatible sidelink communications as described herein. For example, the communications manager 720 may include a sidelink resource manager 725, an IUE coordination message transmitting manager 730, a sidelink message transmitting manager 735, a sidelink message receiving manager 740, an IUE coordination message receiving manager 745, a message decoding manager 750, or any combination thereof. Each of these components may communicate, directly or indirectly, with one another (e.g., via one or more buses).

The communications manager 720 may support wireless communication at a UE in accordance with examples as disclosed herein. The sidelink resource manager 725 may be configured as or otherwise support a means for selecting, from a resource pool for sidelink communications, a set of resources for one or more sidelink messages to be performed by the UE. In some examples, the sidelink resource manager 725 may be configured as or otherwise support a means for selecting an additional resource to transmit a resource reservation for an earliest resource of the set of resources, the selection of the additional resource based on a time interval between the additional resource and the earliest resource satisfying a time threshold. The IUE coordination message transmitting manager 730 may be configured as or otherwise support a means for transmitting, via the additional resource, an IUE coordination message including an indication of the earliest resource within a first-stage SCI portion of the IUE coordination message. The sidelink message transmitting manager 735 may be configured as or otherwise support a means for transmitting a first sidelink message of the one or more sidelink messages within the earliest resource indicated via the first-stage SCI portion of the IUE coordination message.

In some examples, the IUE coordination message transmitting manager 730 may be configured as or otherwise support a means for transmitting, via a second-stage SCI portion of the IUE coordination message, a data portion of the IUE coordination message, or both, IUE coordination information including an indication of the set of resources for the one or more sidelink messages based on selecting the set of resources. In some examples, the second-stage SCI portion, the data portion, or both, is unable to be decoded by reduced-capability UEs. In some examples, the indication of the earliest resource within the first-stage SCI portion is capable of being decoded by reduced-capability UEs.

In some examples, the IUE coordination message transmitting manager 730 may be configured as or otherwise support a means for transmitting a second IUE coordination message including a second indication of the earliest resource in a first-stage SCI portion of the second IUE coordination message, where the second IUE coordination message is transmitted prior to the IUE coordination message. In some examples, the IUE coordination message transmitting manager 730 may be configured as or otherwise support a means for transmitting the IUE coordination message via the additional resource based on a second time interval between transmission of the second IUE coordination message and the earliest resource of the set of resources failing to satisfy the time threshold.

In some examples, the IUE coordination message transmitting manager 730 may be configured as or otherwise support a means for transmitting, via the first-stage SCI portion of the IUE coordination message, an indication of a set of multiple subchannels of the earliest resource, where a last subchannel of the set of multiple subchannels is within the resource pool in a frequency domain, where the first sidelink message is transmitted via the set of multiple subchannels. In some examples, the IUE coordination message transmitting manager 730 may be configured as or otherwise support a means for transmitting, via the first-stage SCI portion of the IUE coordination message, one or more FDRI field values including an indication of a subchannel of the earliest resource, where the first sidelink message is transmitted via at least the subchannel. In some examples, the subchannel includes an initial subchannel of the earliest resource.

In some examples, the IUE coordination message transmitting manager 730 may be configured as or otherwise support a means for transmitting, via the first-stage SCI portion of the IUE coordination message, one or more TDRI field values associated with the earliest resource, one or more FDRI field values associated with the earliest resource, or both.

In some examples, the sidelink message transmitting manager 735 may be configured as or otherwise support a means for transmitting, via the first sidelink message, an indication of a second resource of the set of resources. In some examples, the sidelink message transmitting manager 735 may be configured as or otherwise support a means for transmitting a second sidelink message via the second resource based on transmitting the indication of the second resource via the first sidelink message.

In some examples, the time interval satisfies the time threshold if the time interval is less than or equal to the time threshold. In some examples, the time threshold includes thirty-two slots. In some examples, the IUE coordination message receiving manager 745 may be configured as or otherwise support a means for receiving a second IUE coordination message including an indication of a second resource for one or more additional sidelink messages to be performed by a second UE. In some examples, the IUE coordination message transmitting manager 730 may be configured as or otherwise support a means for relaying the second IUE coordination message to at least a third UE.

In some examples, the IUE coordination message receiving manager 745 may be configured as or otherwise support a means for receiving, via the second IUE coordination message, one or more TDRI field values associated with a relative timing of the one or more additional sidelink messages. In some examples, the IUE coordination message transmitting manager 730 may be configured as or otherwise support a means for transmitting, via the relayed second IUE coordination message, one or more additional TDRI field values associated with the relative timing of the one or more additional sidelink messages.

In some examples, the sidelink resource manager 725 may be configured as or otherwise support a means for selecting, from the resource pool for sidelink communications, a second set of resources for the one or more sidelink messages to be performed by the UE, where selecting the second set of resources occurs prior to selecting the set of resources. In some examples, the sidelink resource manager 725 may be configured as or otherwise support a means for determining that a second additional resource to transmit a resource reservation for an earliest resource of the second set of resources is unable to be identified, where selecting the set of resources, selecting the additional resource, or both, is based on determining that a second additional resource to transmit a resource reservation for an earliest resource of the second set of resources is unable to be identified. In some examples, the IUE coordination message is transmitted via a single subchannel. In some examples, the first-stage SCI portion of the IUE coordination message includes one or more bit field values which indicate that the first-stage SCI portion is associated with the IUE coordination message.

Additionally or alternatively, the communications manager 720 may support wireless communication at a first UE in accordance with examples as disclosed herein. In some examples, the sidelink resource manager 725 may be configured as or otherwise support a means for selecting, from a resource pool for sidelink communications, a set of resources for one or more sidelink messages from a second UE to the first UE. In some examples, the sidelink resource manager 725 may be configured as or otherwise support a means for selecting an additional resource to transmit a resource reservation for an earliest resource of the set of resources, the selection of the additional resource based on a time interval between the additional resource and the earliest resource satisfying a time threshold. In some examples, the IUE coordination message transmitting manager 730 may be configured as or otherwise support a means for transmitting, via the additional resource, an IUE coordination message including an indication of the earliest resource within a first-stage SCI portion of the IUE coordination message. The sidelink message receiving manager 740 may be configured as or otherwise support a means for receiving, from the second UE, a first sidelink message of the one or more sidelink messages within the earliest resource indicated via the first-stage SCI portion of the IUE coordination message.

In some examples, the IUE coordination message transmitting manager 730 may be configured as or otherwise support a means for transmitting, to the second UE via a second-stage SCI portion of the IUE coordination message, a data portion of the IUE coordination message, or both, IUE coordination information including an indication of the set of resources for the one or more sidelink messages based on selecting the set of resources. In some examples, the second-stage SCI portion, the data portion, or both, is unable to be decoded by reduced-capability UEs. In some examples, the indication of the earliest resource within the first-stage SCI portion is capable of being decoded by reduced-capability UEs.

In some examples, the IUE coordination message transmitting manager 730 may be configured as or otherwise support a means for transmitting a second IUE coordination message including a second indication of the earliest resource within a first-stage SCI portion of the second IUE coordination message, where the second IUE coordination message is transmitted prior to the IUE coordination message. In some examples, the IUE coordination message transmitting manager 730 may be configured as or otherwise support a means for transmitting the IUE coordination message via the additional resource based on a second time interval between transmission of the second IUE coordination message and the earliest resource of the set of resources failing to satisfy the time threshold. In some examples, the IUE coordination message transmitting manager 730 may be configured as or otherwise support a means for transmitting, via the first-stage SCI portion of the IUE coordination message, an indication of a set of multiple subchannels of the earliest resource, where a last subchannel of the set of multiple subchannels is within the resource pool in a frequency domain, where the first sidelink message is transmitted via the set of multiple subchannels.

In some examples, the IUE coordination message transmitting manager 730 may be configured as or otherwise support a means for transmitting, via the first-stage SCI portion of the IUE coordination message, one or more FDRI field values including an indication of a subchannel of the earliest resource, where the first sidelink message is transmitted via at least the subchannel. In some examples, the subchannel includes an initial subchannel of the earliest resource. In some examples, the IUE coordination message transmitting manager 730 may be configured as or otherwise support a means for transmitting, via the first-stage SCI portion of the IUE coordination message, one or more TDRI field values associated with the earliest resource, one or more FDRI field values associated with the earliest resource, or both.

In some examples, the sidelink message receiving manager 740 may be configured as or otherwise support a means for receiving, via the first sidelink message, an indication of a second resource of the set of resources. In some examples, the sidelink message receiving manager 740 may be configured as or otherwise support a means for receiving, from the second UE, a second sidelink message via the second resource based on transmitting the indication of the second resource via the first sidelink message.

In some examples, the time interval satisfies the time threshold if the time interval is less than or equal to the time threshold. In some examples, the time threshold includes thirty-two slots.

In some examples, the IUE coordination message receiving manager 745 may be configured as or otherwise support a means for receiving a second IUE coordination message including an indication of a second resource for one or more additional sidelink messages to be performed by a second UE. In some examples, the IUE coordination message transmitting manager 730 may be configured as or otherwise support a means for relaying the second IUE coordination message to at least a third UE.

In some examples, the IUE coordination message receiving manager 745 may be configured as or otherwise support a means for receiving, via the second IUE coordination message, one or more TDRI field values associated with a relative timing of the one or more additional sidelink messages. In some examples, the IUE coordination message transmitting manager 730 may be configured as or otherwise support a means for transmitting, via the relayed second IUE coordination message, one or more additional TDRI field values associated with the relative timing of the one or more additional sidelink messages. In some examples, the selection of the additional resource is based on the time interval between the additional resource and the earliest resource being greater than or equal to a second time threshold associated with a processing capability of the first UE, the second UE, or both.

In some examples, the sidelink resource manager 725 may be configured as or otherwise support a means for selecting, from the resource pool for sidelink communications, a second set of resources for the one or more sidelink messages to be performed by the second UE, where selecting the second set of resources occurs prior to selecting the set of resources. In some examples, the sidelink resource manager 725 may be configured as or otherwise support a means for determining that a second additional resource to transmit a resource reservation for an earliest resource of the second set of resources is unable to be identified, where selecting the set of resources, selecting the additional resource, or both, is based on determining that a second additional resource to transmit a resource reservation for an earliest resource of the second set of resources is unable to be identified.

In some examples, the IUE coordination message is transmitted via a single subchannel. In some examples, the first-stage SCI portion of the IUE coordination message includes one or more bit field values which indicate that the first-stage SCI portion is associated with the IUE coordination message.

Additionally or alternatively, the communications manager 720 may support wireless communication at a second UE in accordance with examples as disclosed herein. The IUE coordination message receiving manager 745 may be configured as or otherwise support a means for receiving, from a first UE, an IUE coordination message including an indication of an earliest resource of a set of resources for one or more sidelink messages from the second UE to the first UE, the indication of the earliest resource included within a first-stage SCI portion of the IUE coordination message, the set of resources included within a resource pool for sidelink communications, where a time interval between reception of the SCI message and the earliest resource satisfies a time threshold. In some examples, the sidelink message transmitting manager 735 may be configured as or otherwise support a means for transmitting, a first sidelink message of the one or more sidelink messages within the earliest resource indicated via the first-stage SCI portion of the IUE coordination message.

In some examples, the IUE coordination message receiving manager 745 may be configured as or otherwise support a means for receiving, from the first UE via a second-stage SCI portion of the IUE coordination message, a data portion of the IUE coordination message, or both, IUE coordination information including an indication of the set of resources for transmitting the one or more sidelink messages based on selecting the set of resources. In some examples, the second-stage SCI portion, the data portion, or both, is unable to be decoded by reduced-capability UEs. In some examples, the indication of the earliest resource within the first-stage SCI portion is capable of being decoded by reduced-capability UEs.

In some examples, the IUE coordination message receiving manager 745 may be configured as or otherwise support a means for receiving a second IUE coordination message including a second indication of the earliest resource within a first-stage SCI portion of the second IUE coordination message, where the second IUE coordination message is transmitted prior to the IUE coordination message. In some examples, the IUE coordination message receiving manager 745 may be configured as or otherwise support a means for receiving the IUE coordination message via the additional resource based on a second time interval between transmission of the second IUE coordination message and the earliest resource of the set of resources failing to satisfy the time threshold.

In some examples, the IUE coordination message receiving manager 745 may be configured as or otherwise support a means for receiving, via the first-stage SCI portion of the IUE coordination message, an indication of a set of multiple subchannels of the earliest resource, where a last subchannel of the set of multiple subchannels is within the resource pool in a frequency domain, where the first sidelink message is transmitted via the set of multiple subchannels.

In some examples, the IUE coordination message receiving manager 745 may be configured as or otherwise support a means for receiving, via the first-stage SCI portion of the IUE coordination message, one or more FDRI field values including an indication of a subchannel of the earliest resource, where the first sidelink message is transmitted via at least the subchannel. In some examples, the subchannel includes an initial subchannel of the earliest resource.

In some examples, the IUE coordination message receiving manager 745 may be configured as or otherwise support a means for receiving, via the first-stage SCI portion of the IUE coordination message, one or more TDRI field values associated with the earliest resource, one or more FDRI field values associated with the earliest resource, or both.

In some examples, the sidelink message transmitting manager 735 may be configured as or otherwise support a means for transmitting, via the first sidelink message, an indication of a second resource of the set of resources. In some examples, the sidelink message transmitting manager 735 may be configured as or otherwise support a means for transmitting, from the second UE, a second sidelink message via the second resource based on transmitting the indication of the second resource via the first sidelink message.

In some examples, the time interval satisfies the time threshold if the time interval is less than or equal to the time threshold. In some examples, the time threshold includes thirty-two slots. In some examples, the IUE coordination message transmitting manager 730 may be configured as or otherwise support a means for relaying the IUE coordination message to at least a third UE.

In some examples, the IUE coordination message receiving manager 745 may be configured as or otherwise support a means for receiving, via the IUE coordination message, one or more TDRI field values associated with a relative timing of the one or more additional sidelink messages. In some examples, the IUE coordination message transmitting manager 730 may be configured as or otherwise support a means for transmitting, via the relayed IUE coordination message, one or more additional TDRI field values associated with the relative timing of the one or more additional sidelink messages.

In some examples, the IUE coordination message is transmitted via a single subchannel. In some examples, the first-stage SCI portion of the IUE coordination message includes one or more bit field values which indicate that the first-stage SCI portion is associated with the IUE coordination message.

In some examples, the message decoding manager 750 may be configured as or otherwise support a means for performing one or more blind decoding procedures, where receiving the IUE coordination message is based on performing the one or more blind decoding procedures.

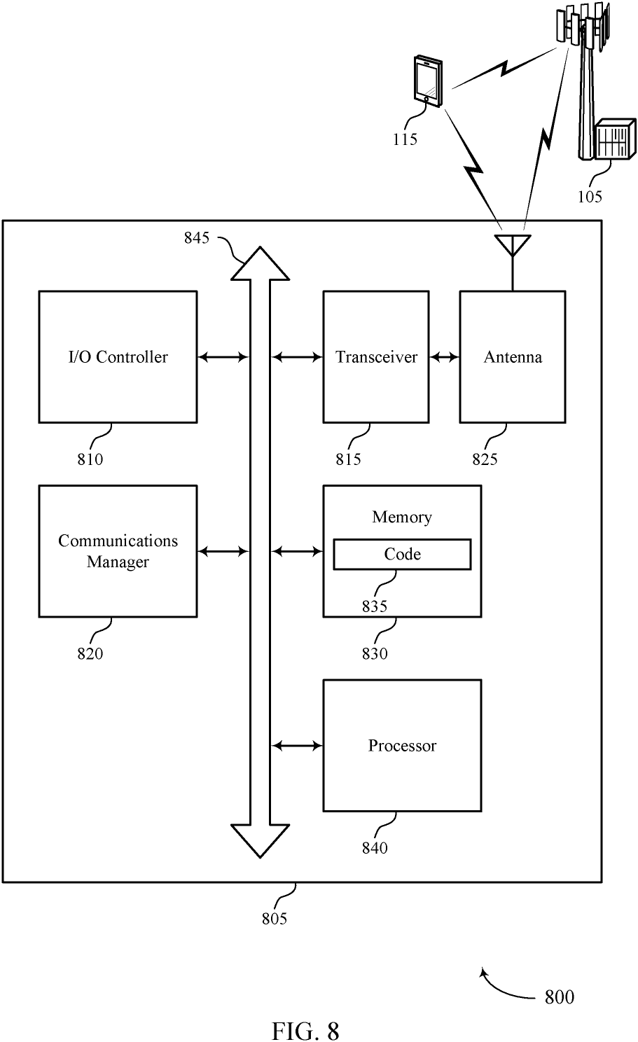

FIG. 8 shows a diagram of a system 800 including a device 805 that supports techniques for backwards-compatible sidelink communications in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for backwards-compatible sidelink communications ). For example, the device 805 or a component of the device 805 may include a processor 840 and memory 830 coupled to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for selecting, from a resource pool for sidelink communications, a set of resources for one or more sidelink messages to be performed by the UE. The communications manager 820 may be configured as or otherwise support a means for selecting an additional resource to transmit a resource reservation for an earliest resource of the set of resources, the selection of the additional resource based on a time interval between the additional resource and the earliest resource satisfying a time threshold. The communications manager 820 may be configured as or otherwise support a means for transmitting, via the additional resource, an IUE coordination message including an indication of the earliest resource within a first-stage SCI portion of the IUE coordination message. The communications manager 820 may be configured as or otherwise support a means for transmitting a first sidelink message of the one or more sidelink messages within the earliest resource indicated via the first-stage SCI portion of the IUE coordination message.

Additionally or alternatively, the communications manager 820 may support wireless communication at a first UE in accordance with examples as disclosed herein. For example, the communications manager 820 may be configured as or otherwise support a means for selecting, from a resource pool for sidelink communications, a set of resources for one or more sidelink messages from a second UE to the first UE. The communications manager 820 may be configured as or otherwise support a means for selecting an additional resource to transmit a resource reservation for an earliest resource of the set of resources, the selection of the additional resource based on a time interval between the additional resource and the earliest resource satisfying a time threshold. The communications manager 820 may be configured as or otherwise support a means for transmitting, via the additional resource, an IUE coordination message including an indication of the earliest resource within a first-stage SCI portion of the IUE coordination message. The communications manager 820 may be configured as or otherwise support a means for receiving, from the second UE, a first sidelink message of the one or more sidelink messages within the earliest resource indicated via the first-stage SCI portion of the IUE coordination message.

Additionally or alternatively, the communications manager 820 may support wireless communication at a second UE in accordance with examples as disclosed herein. For example, the communications manager 820 may be configured as or otherwise support a means for receiving, from a first UE, an IUE coordination message including an indication of an earliest resource of a set of resources for one or more sidelink messages from the second UE to the first UE, the indication of the earliest resource included within a first-stage SCI portion of the IUE coordination message, the set of resources included within a resource pool for sidelink communications, where a time interval between reception of the SCI message and the earliest resource satisfies a time threshold. The communications manager 820 may be configured as or otherwise support a means for transmitting, a first sidelink message of the one or more sidelink messages within the earliest resource indicated via the first-stage SCI portion of the IUE coordination message.

By including or configuring the communications manager 820 in accordance with examples as described herein, the device 805 may support techniques for backwards-compatible sidelink reservations to improve sidelink network coordination and reduce conflicts within sidelink resources. In particular, by transmitting some information related to reserved sidelink resources via SCI messages, techniques described herein may enable backwards compatibility for sidelink reservations between Re17 and Re16 UEs 115. By enabling reservations of sidelink resources to be understood by both Re17 and Re16 UEs 115, techniques described herein may reduce potential conflicts within sidelink resources, and may enable more efficient and reliable communications within the wireless communications system 100.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of techniques for backwards-compatible sidelink communications as described herein, or the processor 840 and the memory 830 may be otherwise configured to perform or support such operations.

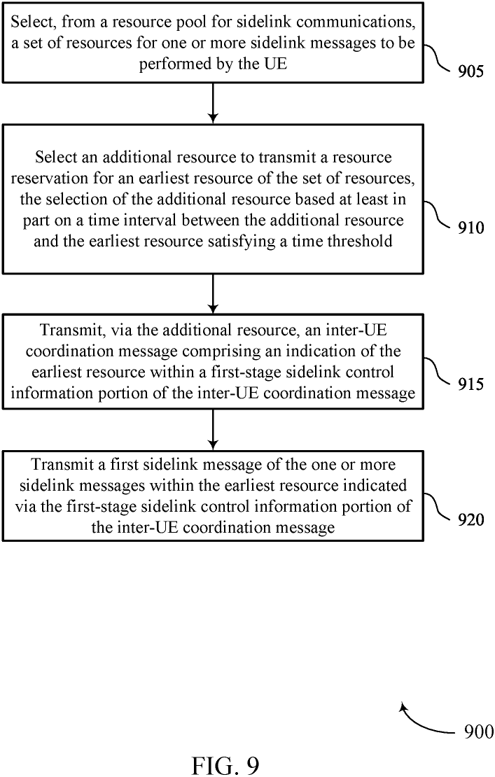

FIG. 9 shows a flowchart illustrating a method 900 that supports techniques for backwards-compatible sidelink communications in accordance with aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 905, the method may include selecting, from a resource pool for sidelink communications, a set of resources for one or more sidelink messages to be performed by the UE. The operations of 905 may be performed in accordance with examples as disclosed herein. In some examples, aspects of the operations of 905 may be performed by a sidelink resource manager 725 as described with reference to FIG. 7.

At 910, the method may include selecting an additional resource to transmit a resource reservation for an earliest resource of the set of resources, the selection of the additional resource based on a time interval between the additional resource and the earliest resource satisfying a time threshold. The operations of 910 may be performed in accordance with examples as disclosed herein. In some examples, aspects of the operations of 910 may be performed by a sidelink resource manager 725 as described with reference to FIG. 7.

At 915, the method may include transmitting, via the additional resource, an IUE coordination message including an indication of the earliest resource within a first-stage SCI portion of the IUE coordination message. The operations of 915 may be performed in accordance with examples as disclosed herein. In some examples, aspects of the operations of 915 may be performed by an SCI message transmitting manager 730 as described with reference to FIG. 7.

At 920, the method may include transmitting a first sidelink message of the one or more sidelink messages within the earliest resource indicated via the first-stage SCI portion of the IUE coordination message. The operations of 920 may be performed in accordance with examples as disclosed herein. In some examples, aspects of the operations of 920 may be performed by a sidelink message transmitting manager 735 as described with reference to FIG. 7.

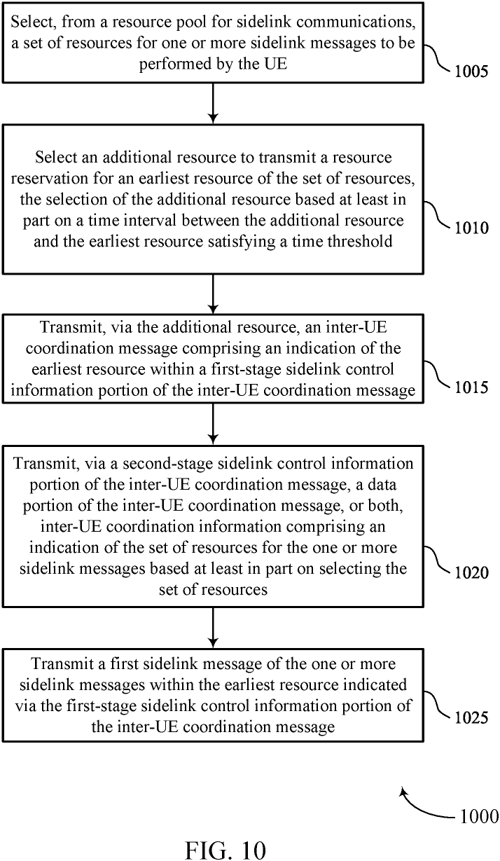

FIG. 10 shows a flowchart illustrating a method 1000 that supports techniques for backwards-compatible sidelink communications in accordance with aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1005, the method may include selecting, from a resource pool for sidelink communications, a set of resources for one or more sidelink messages to be performed by the UE. The operations of 1005 may be performed in accordance with examples as disclosed herein. In some examples, aspects of the operations of 1005 may be performed by a sidelink resource manager 725 as described with reference to FIG. 7.

At 1010, the method may include selecting an additional resource to transmit a resource reservation for an earliest resource of the set of resources, the selection of the additional resource based on a time interval between the additional resource and the earliest resource satisfying a time threshold. The operations of 1010 may be performed in accordance with examples as disclosed herein. In some examples, aspects of the operations of 1010 may be performed by a sidelink resource manager 725 as described with reference to FIG. 7.

At 1015, the method may include transmitting, via the additional resource, an IUE coordination message including an indication of the earliest resource within a first-stage SCI portion of the IUE coordination message. The operations of 1015 may be performed in accordance with examples as disclosed herein. In some examples, aspects of the operations of 1015 may be performed by an SCI message transmitting manager 730 as described with reference to FIG. 7.

At 1020, the method may include transmitting, via a second-stage SCI portion of the IUE coordination message, a data portion of the IUE coordination message, or both, IUE coordination information including an indication of the set of resources for the one or more sidelink messages based on selecting the set of resources. The operations of 1020 may be performed in accordance with examples as disclosed herein. In some examples, aspects of the operations of 1020 may be performed by an IUE coordination information transmitting manager 750 as described with reference to FIG. 7.

At 1025, the method may include transmitting a first sidelink message of the one or more sidelink messages within the earliest resource indicated via the first-stage SCI portion of the IUE coordination message. The operations of 1025 may be performed in accordance with examples as disclosed herein. In some examples, aspects of the operations of 1025 may be performed by a sidelink message transmitting manager 735 as described with reference to FIG. 7.

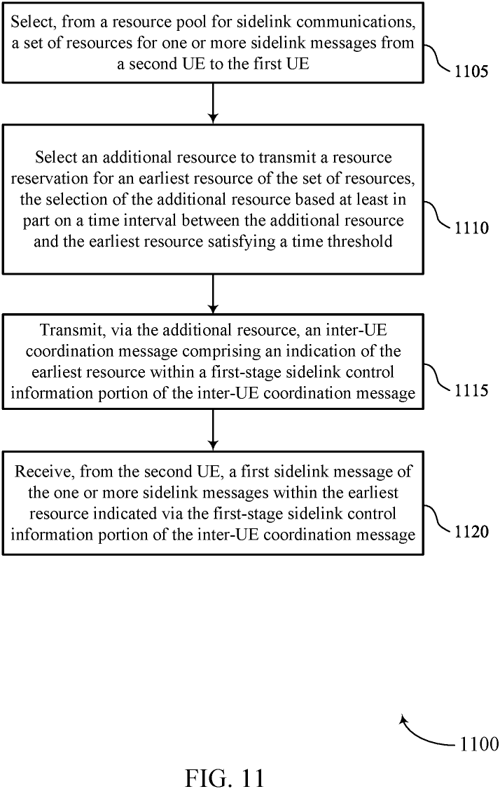

FIG. 11 shows a flowchart illustrating a method 1100 that supports techniques for backwards-compatible sidelink communications in accordance with aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1105, the method may include selecting, from a resource pool for sidelink communications, a set of resources for one or more sidelink messages from a second UE to the first UE. The operations of 1105 may be performed in accordance with examples as disclosed herein. In some examples, aspects of the operations of 1105 may be performed by a sidelink resource manager 725 as described with reference to FIG. 7.

At 1110, the method may include selecting an additional resource to transmit a resource reservation for an earliest resource of the set of resources, the selection of the additional resource based on a time interval between the additional resource and the earliest resource satisfying a time threshold. The operations of 1110 may be performed in accordance with examples as disclosed herein. In some examples, aspects of the operations of 1110 may be performed by a sidelink resource manager 725 as described with reference to FIG. 7.

At 1115, the method may include transmitting, via the additional resource, an IUE coordination message including an indication of the earliest resource within a first-stage SCI portion of the IUE coordination message. The operations of 1115 may be performed in accordance with examples as disclosed herein. In some examples, aspects of the operations of 1115 may be performed by an SCI message transmitting manager 730 as described with reference to FIG. 7.

At 1120, the method may include receiving, from the second UE, a first sidelink message of the one or more sidelink messages within the earliest resource indicated via the first-stage SCI portion of the IUE coordination message. The operations of 1120 may be performed in accordance with examples as disclosed herein. In some examples, aspects of the operations of 1120 may be performed by a sidelink message receiving manager 740 as described with reference to FIG. 7.

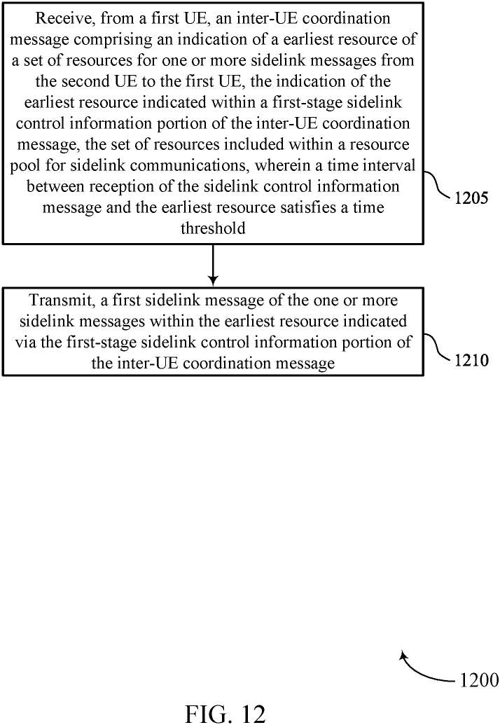

FIG. 12 shows a flowchart illustrating a method 1200 that supports techniques for backwards-compatible sidelink communications in accordance with aspects of the present disclosure. The operations of the method 1200 may be implemented by a UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1205, the method may include receiving, from a first UE, an SCI message including an indication of a earliest resource of a set of resources for one or more sidelink messages from the second UE to the first UE, the indication of the earliest resource indicated within a first-stage SCI portion of the IUE coordination message, the set of resources included within a resource pool for sidelink communications, where a time interval between reception of the SCI message and the earliest resource satisfies a time threshold. The operations of 1205 may be performed in accordance with examples as disclosed herein. In some examples, aspects of the operations of 1205 may be performed by an SCI message receiving manager 745 as described with reference to FIG. 7.

At 1210, the method may include transmitting, a first sidelink message of the one or more sidelink messages within the earliest resource indicated via the first-stage SCI portion of the IUE coordination message. The operations of 1210 may be performed in accordance with examples as disclosed herein. In some examples, aspects of the operations of 1210 may be performed by an SCI message transmitting manager 730 as described with reference to FIG. 7.

The following provides an overview of aspects of the present disclosure:

Aspect 1: A method for wireless communication at a UE, comprising: selecting, from a resource pool for sidelink communications, a set of resources for one or more sidelink messages to be performed by the UE; selecting an additional resource to transmit a resource reservation for an earliest resource of the set of resources, the selection of the additional resource based at least in part on a time interval between the additional resource and the earliest resource satisfying a time threshold; transmitting, via the additional resource, an IUE coordination message comprising an indication of the earliest resource within a first-stage SCI portion of the IUE coordination message; and transmitting a first sidelink message of the one or more sidelink messages within the earliest resource indicated via the first-stage SCI portion of the IUE coordination message.

Aspect 2: The method of aspect 1, further comprising: transmitting, via a second-stage SCI portion of the IUE coordination message, a data portion of the IUE coordination message, or both, IUE coordination information comprising an indication of the set of resources for the one or more sidelink messages based at least in part on selecting the set of resources.

Aspect 3: The method of aspect 2, wherein the second-stage SCI portion, the data portion, or both, is unable to be decoded by reduced-capability UEs, and the indication of the earliest resource within the first-stage SCI portion is capable of being decoded by reduced-capability UEs.

Aspect 4: The method of any of aspects 1 through 3, further comprising: transmitting a second IUE coordination message comprising a second indication of the earliest resource in a first-stage SCI portion of the second IUE coordination message, wherein the second IUE coordination message is transmitted prior to the IUE coordination message; and transmitting the IUE coordination message via the additional resource based at least in part on a second time interval between transmission of the second IUE coordination message and the earliest resource of the set of resources failing to satisfy the time threshold.

Aspect 5: The method of any of aspects 1 through 4, further comprising: transmitting, via the first-stage SCI portion of the IUE coordination message, an indication of a plurality of subchannels of the earliest resource, wherein a last subchannel of the plurality of subchannels is within the resource pool in a frequency domain, wherein the first sidelink message is transmitted via the plurality of subchannels.

Aspect 6: The method of any of aspects 1 through 5, further comprising: transmitting, via the first-stage SCI portion of the IUE coordination message, one or more FDRI field values comprising an indication of a subchannel of the earliest resource, wherein the first sidelink message is transmitted via at least the subchannel.

Aspect 7: The method of aspect 6, wherein the subchannel comprises an initial subchannel of the earliest resource.

Aspect 8: The method of any of aspects 1 through 7, further comprising: transmitting, via the first-stage SCI portion of the IUE coordination message, one or more TDRI field values associated with the earliest resource, one or more FDRI field values associated with the earliest resource, or both.

Aspect 9: The method of any of aspects 1 through 8, further comprising: transmitting, via the first sidelink message, an indication of a second resource of the set of resources; and transmitting a second sidelink message via the second resource based at least in part on transmitting the indication of the second resource via the first sidelink message.

Aspect 10: The method of any of aspects 1 through 9, wherein the time interval satisfies the time threshold if the time interval is less than or equal to the time threshold.

Aspect 11: The method of any of aspects 1 through 10, wherein the time threshold comprises thirty-two slots.

Aspect 12: The method of any of aspects 1 through 11, further comprising: receiving a second IUE coordination message comprising an indication of a second resource for one or more additional sidelink messages to be performed by a second UE; and relaying the second IUE coordination message to at least a third UE.

Aspect 13: The method of aspect 12, further comprising: receiving, via the second IUE coordination message, one or more TDRI field values associated with a relative timing of the one or more additional sidelink messages; and transmitting, via the relayed second IUE coordination message, one or more additional TDRI field values associated with the relative timing of the one or more additional sidelink messages.

Aspect 14: The method of any of aspects 1 through 13, further comprising: selecting, from the resource pool for sidelink communications, a second set of resources for the one or more sidelink messages to be performed by the UE, wherein selecting the second set of resources occurs prior to selecting the set of resources; and determining that a second additional resource to transmit a resource reservation for an earliest resource of the second set of resources is unable to be identified, wherein selecting the set of resources, selecting the additional resource, or both, is based at least in part on determining that a second additional resource to transmit a resource reservation for an earliest resource of the second set of resources is unable to be identified.

Aspect 15: The method of any of aspects 1 through 14, wherein the first-stage SCI portion of the IUE coordination message comprises one or more bit field values which indicate that the first-stage SCI portion is associated with the IUE coordination message.

Aspect 16: A method for wireless communication at a first UE, comprising: selecting, from a resource pool for sidelink communications, a set of resources for one or more sidelink messages from a second UE to the first UE; selecting an additional resource to transmit a resource reservation for an earliest resource of the set of resources, the selection of the additional resource based at least in part on a time interval between the additional resource and the earliest resource satisfying a time threshold; transmitting, via the additional resource, an IUE coordination message comprising an indication of the earliest resource within a first-stage SCI portion of the IUE coordination message; and receiving, from the second UE, a first sidelink message of the one or more sidelink messages within the earliest resource indicated via the first-stage SCI portion of the IUE coordination message.

Aspect 17: The method of aspect 16, further comprising: transmitting, to the second UE via a second-stage SCI portion of the IUE coordination message, a data portion of the IUE coordination message, or both, IUE coordination information comprising an indication of the set of resources for the one or more sidelink messages based at least in part on selecting the set of resources.

Aspect 18: The method of aspect 17, wherein the second-stage SCI portion, the data portion, or both, is unable to be decoded by reduced-capability UEs, and the indication of the earliest resource within the first-stage SCI portion is capable of being decoded by reduced-capability UEs.

Aspect 19: The method of any of aspects 16 through 18, further comprising: transmitting a second IUE coordination message comprising a second indication of the earliest resource within a first-stage SCI portion of the second IUE coordination message, wherein the second IUE coordination message is transmitted prior to the IUE coordination message; and transmitting the IUE coordination message via the additional resource based at least in part on a second time interval between transmission of the second IUE coordination message and the earliest resource of the set of resources failing to satisfy the time threshold.

Aspect 20: The method of any of aspects 16 through 19, further comprising: transmitting, via the first-stage SCI portion of the IUE coordination message, an indication of a plurality of subchannels of the earliest resource, wherein a last subchannel of the plurality of subchannels is within the resource pool in a frequency domain, wherein the first sidelink message is transmitted via the plurality of subchannels.

Aspect 21: The method of any of aspects 16 through 20, further comprising: transmitting, via the first-stage SCI portion of the IUE coordination message, one or more FDRI field values comprising an indication of a subchannel of the earliest resource, wherein the first sidelink message is transmitted via at least the subchannel.

Aspect 22: The method of aspect 21, wherein the subchannel comprises an initial subchannel of the earliest resource.

Aspect 23: The method of any of aspects 16 through 22, further comprising: transmitting, via the first-stage SCI portion of the IUE coordination message, one or more TDRI field values associated with the earliest resource, one or more FDRI field values associated with the earliest resource, or both.

Aspect 24: The method of any of aspects 16 through 23, further comprising: receiving, via the first sidelink message, an indication of a second resource of the set of resources; and receiving, from the second UE, a second sidelink message via the second resource based at least in part on transmitting the indication of the second resource via the first sidelink message.

Aspect 25: The method of any of aspects 16 through 24, wherein the time interval satisfies the time threshold if the time interval is less than or equal to the time threshold.

Aspect 26: The method of any of aspects 16 through 25, wherein the time threshold comprises thirty-two slots.

Aspect 27: The method of any of aspects 16 through 26, further comprising: receiving a second IUE coordination message comprising an indication of a second resource for one or more additional sidelink messages to be performed by a second UE; and relaying the second IUE coordination message to at least a third UE.

Aspect 28: The method of aspect 27, further comprising: receiving, via the second IUE coordination message, one or more TDRI field values associated with a relative timing of the one or more additional sidelink messages; and transmitting, via the relayed second IUE coordination message, one or more additional TDRI field values associated with the relative timing of the one or more additional sidelink messages.

Aspect 29: The method of any of aspects 27 through 28, wherein the selection of the additional resource is based at least in part on the time interval between the additional resource and the earliest resource being greater than or equal to a second time threshold associated with a processing capability of the first UE, the second UE, or both.

Aspect 30: The method of any of aspects 16 through 29, further comprising: selecting, from the resource pool for sidelink communications, a second set of resources for the one or more sidelink messages to be performed by the second UE, wherein selecting the second set of resources occurs prior to selecting the set of resources; and determining that a second additional resource to transmit a resource reservation for an earliest resource of the second set of resources is unable to be identified, wherein selecting the set of resources, selecting the additional resource, or both, is based at least in part on determining that a second additional resource to transmit a resource reservation for an earliest resource of the second set of resources is unable to be identified.

Aspect 31: The method of any of aspects 16 through 30, wherein the first-stage SCI portion of the IUE coordination message comprises one or more bit field values which indicate that the first-stage SCI portion is associated with the IUE coordination message.

Aspect 32: A method for wireless communication at a second UE, comprising: receiving, from a first UE, an IUE coordination message comprising an indication of an earliest resource of a set of resources for one or more sidelink messages from the second UE to the first UE, the indication of the earliest resource included within a first-stage SCI portion of the IUE coordination message, the set of resources included within a resource pool for sidelink communications, wherein a time interval between reception of the SCI message and the earliest resource satisfies a time threshold; and transmitting, a first sidelink message of the one or more sidelink messages within the earliest resource indicated via the first-stage SCI portion of the IUE coordination message.

Aspect 33: The method of aspect 32, further comprising: receiving, from the first UE via a second-stage SCI portion of the IUE coordination message, a data portion of the IUE coordination message, or both, IUE coordination information comprising an indication of the set of resources for transmitting the one or more sidelink messages based at least in part on selecting the set of resources.

Aspect 34: The method of aspect 33, wherein the second-stage SCI portion, the data portion, or both, is unable to be decoded by reduced-capability UEs, and the indication of the earliest resource within the first-stage SCI portion is capable of being decoded by reduced-capability UEs.

Aspect 35: The method of any of aspects 32 through 34, further comprising: receiving a second IUE coordination message comprising a second indication of the earliest resource within a first-stage SCI portion of the second IUE coordination message, wherein the second IUE coordination message is transmitted prior to the IUE coordination message; and receiving the IUE coordination message via the additional resource based at least in part on a second time interval between transmission of the second IUE coordination message and the earliest resource of the set of resources failing to satisfy the time threshold.

Aspect 36: The method of any of aspects 32 through 35, further comprising: receiving, via the first-stage SCI portion of the IUE coordination message, an indication of a plurality of subchannels of the earliest resource, wherein a last subchannel of the plurality of subchannels is within the resource pool in a frequency domain, wherein the first sidelink message is transmitted via the plurality of subchannels.

Aspect 37: The method of any of aspects 32 through 36, further comprising: receiving, via the first-stage SCI portion of the IUE coordination message, one or more FDRI field values comprising an indication of a subchannel of the earliest resource, wherein the first sidelink message is transmitted via at least the subchannel.

Aspect 38: The method of aspect 37, wherein the subchannel comprises an initial subchannel of the earliest resource.

Aspect 39: The method of any of aspects 32 through 38, further comprising: receiving, via the first-stage SCI portion of the IUE coordination message, one or more TDRI field values associated with the earliest resource, one or more FDRI field values associated with the earliest resource, or both.

Aspect 40: The method of any of aspects 32 through 39, further comprising: transmitting, via the first sidelink message, an indication of a second resource of the set of resources; and transmitting, from the second UE, a second sidelink message via the second resource based at least in part on transmitting the indication of the second resource via the first sidelink message.

Aspect 41: The method of any of aspects 32 through 40, wherein the time interval satisfies the time threshold if the time interval is less than or equal to the time threshold.

Aspect 42: The method of any of aspects 32 through 41, wherein the time threshold comprises thirty-two slots.

Aspect 43: The method of any of aspects 32 through 42, further comprising: relaying the IUE coordination message to at least a third UE.

Aspect 44: The method of aspect 43, further comprising: receiving, via the IUE coordination message, one or more TDRI field values associated with a relative timing of the one or more additional sidelink messages; and transmitting, via the relayed IUE coordination message, one or more additional TDRI field values associated with the relative timing of the one or more additional sidelink messages.

Aspect 45: The method of any of aspects 32 through 44, wherein the first-stage SCI portion of the IUE coordination message comprises one or more bit field values which indicate that the first-stage SCI portion is associated with the IUE coordination message.

Aspect 46: The method of any of aspects 32 through 45, further comprising: performing one or more blind decoding procedures, wherein receiving the IUE coordination message is based at least in part on performing the one or more blind decoding procedures.

Aspect 47: The method of any of aspects 32 through 46, further comprising: performing one or more decoding procedures for the IUE coordination message regardless of one or more parameters indicated via the IUE coordination message, the one or more parameters comprising a cast type, a destination identifier, a source identifier, feedback distance information, or any combination thereof.

Aspect 48: An apparatus for wireless communication at a UE, comprising a processor; memory coupled with the processor; and instructions stored in the memory and executable by the processor to cause the apparatus to perform a method of any of aspects 1 through 15.

Aspect 49: An apparatus for wireless communication at a UE, comprising at least one means for performing a method of any of aspects 1 through 15.

Aspect 50: A non-transitory computer-readable medium storing code for wireless communication at a UE, the code comprising instructions executable by a processor to perform a method of any of aspects 1 through 15.

Aspect 51: An apparatus for wireless communication at a first UE, comprising a processor; memory coupled with the processor; and instructions stored in the memory and executable by the processor to cause the apparatus to perform a method of any of aspects 16 through 31.

Aspect 52: An apparatus for wireless communication at a first UE, comprising at least one means for performing a method of any of aspects 16 through 31.

Aspect 53: A non-transitory computer-readable medium storing code for wireless communication at a first UE, the code comprising instructions executable by a processor to perform a method of any of aspects 16 through 31.

Aspect 54: An apparatus for wireless communication at a second UE, comprising a processor; memory coupled with the processor; and instructions stored in the memory and executable by the processor to cause the apparatus to perform a method of any of aspects 32 through 47.

Aspect 55: An apparatus for wireless communication at a second UE, comprising at least one means for performing a method of any of aspects 32 through 47.

Aspect 56: A non-transitory computer-readable medium storing code for wireless communication at a second UE, the code comprising instructions executable by a processor to perform a method of any of aspects 32 through 47.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
select, from a resource pool for sidelink communications, a set of resources for one or more sidelink messages to be performed by the UE;
select an additional resource to transmit a resource reservation for an earliest resource of the set of resources, the selection of the additional resource based at least in part on a time interval between the additional resource and the earliest resource satisfying a time threshold;
transmit, via the additional resource, an inter-UE coordination message comprising an indication of the earliest resource within a first-stage sidelink control information portion of the inter-UE coordination message; and
transmit a first sidelink message of the one or more sidelink messages within the earliest resource indicated via the first-stage sidelink control information portion of the inter-UE coordination message.

2. The apparatus of claim 1, wherein the processor is further configured to:
transmit, via a second-stage sidelink control information portion of the inter-UE coordination message, a data portion of the inter-UE coordination message, or both, inter-UE coordination information comprising an indication of the set of resources for the one or more sidelink messages based at least in part on selecting the set of resources.

3. The apparatus of claim 2, wherein the second-stage sidelink control information portion, the data portion, or both, is unable to be decoded by reduced-capability UEs, and wherein the indication of the earliest resource within the first-stage sidelink control information portion is capable of being decoded by the reduced-capability UEs.

4. The apparatus of claim 1, wherein the processor is further configured to:
transmit, via the first-stage sidelink control information portion of the inter-UE coordination message, an indication of a plurality of subchannels of the earliest resource, wherein a last subchannel of the plurality of subchannels is within the resource pool in a frequency domain, wherein the first sidelink message is transmitted via the plurality of subchannels.

5. The apparatus of claim 1, wherein the processor is further configured to:
transmit, via the first-stage sidelink control information portion of the inter-UE coordination message, one or more frequency domain resource indication field values comprising an indication of a subchannel of the earliest resource, wherein the first sidelink message is transmitted via at least the subchannel.

6. The apparatus of claim 5, wherein the subchannel comprises an initial subchannel of the earliest resource.

7. The apparatus of claim 1, wherein the processor is further configured to:
transmit, via the first-stage sidelink control information portion of the inter-UE coordination message, one or more time domain resource indication field values associated with the earliest resource, one or more frequency domain resource indication field values associated with the earliest resource, or both.

8. The apparatus of claim 1, wherein the time interval satisfies the time threshold if the time interval is less than or equal to the time threshold.

9. The apparatus of claim 1, wherein the time threshold comprises thirty-two slots.

10. The apparatus of claim 1, wherein the processor is further configured to:
select, from the resource pool for sidelink communications, a second set of resources for the one or more sidelink messages to be performed by the UE, wherein selecting the second set of resources occurs prior to selecting the set of resources; and
determine that a second additional resource to transmit a resource reservation for an earliest resource of the second set of resources is unable to be identified, wherein selecting the set of resources, selecting the additional resource, or both, is based at least in part on determining that the second additional resource to transmit the resource reservation for the earliest resource of the second set of resources is unable to be identified.

11. An apparatus for wireless communication at a first user equipment (UE), comprising:
a processor;
memory coupled with the processor; and
instructions stored in the memory and executable by the processor to cause the apparatus to:
select, from a resource pool for sidelink communications, a set of resources for one or more sidelink messages from a second UE to the first UE;
select an additional resource to transmit a resource reservation for an earliest resource of the set of resources, the selection of the additional resource based at least in part on a time interval between the additional resource and the earliest resource satisfying a time threshold;
transmit, via the additional resource, an inter-UE coordination message comprising an indication of the earliest resource within a first-stage sidelink control information portion of the inter-UE coordination message; and
receive, from the second UE, a first sidelink message of the one or more sidelink messages within the earliest resource indicated via the first-stage sidelink control information portion of the inter-UE coordination message.

12. The apparatus of claim 11, wherein the processor is further configured to:
transmit, to the second UE via a second-stage sidelink control information portion of the inter-UE coordination message, a data portion of the inter-UE coordination message, or both, inter-UE coordination information comprising an indication of the set of resources for the one or more sidelink messages based at least in part on selecting the set of resources.

13. The apparatus of claim 12, wherein the second-stage sidelink control information portion, the data portion, or both, is unable to be decoded by reduced-capability UEs, and wherein the indication of the earliest resource within the first-stage sidelink control information portion is capable of being decoded by the reduced-capability UEs.

14. The apparatus of claim 11, wherein the processor is further configured to:
transmit, via the first-stage sidelink control information portion of the inter-UE coordination message, an indication of a plurality of subchannels of the earliest resource, wherein a last subchannel of the plurality of subchannels is within the resource pool in a frequency domain, wherein the first sidelink message is transmitted via the plurality of subchannels.

15. The apparatus of claim 11, wherein the processor is further configured to:
transmit, via the first-stage sidelink control information portion of the inter-UE coordination message, one or more frequency domain resource indication field values comprising an indication of a subchannel of the earliest resource, wherein the first sidelink message is transmitted via at least the subchannel.

16. The apparatus of claim 15, wherein the subchannel comprises an initial subchannel of the earliest resource.

17. The apparatus of claim 11, wherein the processor is further configured to:
transmit, via the first-stage sidelink control information portion of the inter-UE coordination message, one or more time domain resource indication field values associated with the earliest resource, one or more frequency domain resource indication field values associated with the earliest resource, or both.

18. The apparatus of claim 11, wherein the time threshold comprises thirty-two slots.

19. The apparatus of claim 11, wherein the processor is further configured to:
select, from the resource pool for sidelink communications, a second set of resources for the one or more sidelink messages to be performed by the second UE, wherein selecting the second set of resources occurs prior to selecting the set of resources; and
determine that a second additional resource to transmit a resource reservation for an earliest resource of the second set of resources is unable to be identified, wherein selecting the set of resources, selecting the additional resource, or both, is based at least in part on determining that the second additional resource to transmit the resource reservation for the earliest resource of the second set of resources is unable to be identified.

20. An apparatus for wireless communication at a second user equipment (UE), comprising:
a processor;
memory coupled with the processor; and
instructions stored in the memory and executable by the processor to cause the apparatus to:
receive, from a first UE, an inter-UE coordination message comprising an indication of an earliest resource of a set of resources for one or more sidelink messages from the second UE to the first UE, the indication of the earliest resource included within a first-stage sidelink control information portion of the inter-UE coordination message, the set of resources included within a resource pool for sidelink communications, wherein a time interval between reception of a sidelink control information message and the earliest resource satisfies a time threshold; and
transmit, a first sidelink message of the one or more sidelink messages within the earliest resource indicated via the first-stage sidelink control information portion of the inter-UE coordination message.

21. The apparatus of claim 20, wherein the processor is further configured to:
receive, from the first UE via a second-stage sidelink control information portion of the inter-UE coordination message, a data portion of the inter-UE coordination message, or both, inter-UE coordination information comprising an indication of the set of resources for transmitting the one or more sidelink messages based at least in part on selecting the set of resources.

22. The apparatus of claim 21, wherein the second-stage sidelink control information portion, the data portion, or both, is unable to be decoded by reduced-capability UEs, and wherein the indication of the earliest resource within the first-stage sidelink control information portion is capable of being decoded by reduced-capability UEs.

23. The apparatus of claim 20, wherein the processor is further configured to:
receive, via the first-stage sidelink control information portion of the inter-UE coordination message, an indication of a plurality of subchannels of the earliest resource, wherein a last subchannel of the plurality of subchannels is within the resource pool in a frequency domain, wherein the first sidelink message is transmitted via the plurality of subchannels.

24. The apparatus of claim 20, wherein the processor is further configured to:
receive, via the first-stage sidelink control information portion of the inter-UE coordination message, one or more frequency domain resource indication field values comprising an indication of a subchannel of the earliest resource, wherein the first sidelink message is transmitted via at least the subchannel.

25. The apparatus of claim 20, wherein the processor is further configured to:
receive, via the first-stage sidelink control information portion of the inter-UE coordination message, one or more time domain resource indication field values associated with the earliest resource, one or more frequency domain resource indication field values associated with the earliest resource, or both.

26. The apparatus of claim 20, wherein the time threshold comprises thirty-two slots.

27. The apparatus of claim 20, wherein the processor is further configured to:
perform one or more blind decoding procedures, wherein receiving the inter-UE coordination message is based at least in part on performing the one or more blind decoding procedures.

28. The apparatus of claim 20, wherein the processor is further configured to:
perform one or more decoding procedures for the inter-UE coordination message regardless of one or more parameters indicated via the inter-UE coordination message, the one or more parameters comprising a cast type, a destination identifier, a source identifier, feedback distance information, or any combination thereof.

29. A method for wireless communication at a user equipment (UE), comprising:
selecting, from a resource pool for sidelink communications, a set of resources for one or more sidelink messages to be performed by the UE;
selecting an additional resource to transmit a resource reservation for an earliest resource of the set of resources, the selection of the additional resource based at least in part on a time interval between the additional resource and the earliest resource satisfying a time threshold;
transmitting, via the additional resource, an inter-UE coordination message comprising an indication of the earliest resource within a first-stage sidelink control information portion of the inter-UE coordination message; and
transmitting a first sidelink message of the one or more sidelink messages within the earliest resource indicated via the first-stage sidelink control information portion of the inter-UE coordination message.

30. The method of claim 29, further comprising:
transmitting, via a second-stage sidelink control information portion of the inter-UE coordination message, a data portion of the inter-UE coordination message, or both, inter-UE coordination information comprising an indication of the set of resources for the one or more sidelink messages based at least in part on selecting the set of resources.
